(19) United States
(12) Patent Application Publication
(10) Pub. No.: US 2022/0278607 A1
(43) Pub. Date: Sep. 1, 2022

(54) ELECTRICAL CONVERTER

(71) Applicant: PRODRIVE TECHNOLOGIES INNOVATION SERVICES B.V., Son en Breugel (NL)

(72) Inventors: Jordi EVERTS, Son (NL); Thomas Valentijn GERRITS, Son (NL)

(21) Appl. No.: 17/608,009

(22) PCT Filed: Apr. 29, 2020
(86) PCT No.: PCT/EP2020/061914

§ 371 Date: Nov. 1, 2021

(30) Foreign Application Priority Data
May 2, 2019 (EP) 19172391.5
Jun. 12, 2019 (NL) 2023292

(51) Int. Cl. H02M 1/42; H02M 1/12; H02M 3/158

(52) U.S. Cl. CPC H02M 1/4216; H02M 1/4233; H02M 1/126; H02M 3/1582

(57) ABSTRACT

A converter for conversion between three-phase AC and a DC signal may include three phase terminals, a first and second DC terminal, conversion circuitry for conversion between three phase voltages of the three-phase AC signal and a first and second intermediate voltage at first and second intermediate nodes, and first and second buck circuits. The buck circuits each have three devices that are actively switchable for connecting switch-node terminals to any one of the three phase terminals. The first buck circuit includes a second switching device connected between the first intermediate node and the first switch-node terminal, and a first filter inductor connected between the first switch-node terminal and the first DC terminal. The second buck circuit has another second switching device connected between the second intermediate node and the second switch-node terminal, and a second filter inductor connected between the second switch-node terminal and the second DC terminal.

### TECHNICAL FIELD

The present disclosure relates to the field of electrical power conversion. In particular, the present disclosure relates to an electrical converter and a method for converting electrical power.

### INTRODUCTION

For example, when the battery of an electric vehicle is charged, the AC voltage from an electrical grid is converted by an electrical converter into a DC voltage which is then provided to the battery that is being charged. For example, an electrical converter may convert a three-phase AC voltage into a DC voltage between the terminals of a DC bus to which the high-voltage (e.g. 200-400 V) battery of the vehicle may be connected. Also wireless charging systems for electric cars, electric motor drives, or gradient amplifiers for Magnetic Resonance Imaging (MRI) scanners typically need such three-phase AC-to-DC conversion to create a high-voltage DC bus from which power can be drawn.

Usually the current that is drawn by the electrical converter from each phase of the three-phase grid, for example when a load draws power from the DC output of the electrical converter, needs to be substantially sinusoidal and substantially in phase with the sinusoidal voltage of that particular phase, resulting in a power factor that is substantially equal to one. Therefore, the three-phase AC-to-DC conversion advantageously requires a three-phase Power Factor Correcting (PFC) electrical AC-to-DC converter. Also low distortion, for example a low Total Harmonic Distortion (THD), of the current drawn from the grid is typically required for such PFC converters.

Conventionally, when the voltage between the DC bus terminals is lower than the full-wave rectified AC voltage, electrical converters are used that comprise a boost-type PFC stage with, e.g., a 700-900 V DC output, which is connected in series with a DC-DC buck converter to generate the desired DC bus voltage, e.g., in the range of 200-400 V. Alternatively, buck-type PFC converters based on the 3^{rd} harmonic active filter principle have been introduced as a single-stage alternative to these conventional two stage converters, reducing the number of conversion stages in order to achieve a higher overall energy conversion efficiency and a higher power-to-volume ratio (i.e. a higher power density).

For example, reference T. Soeiro, T. Friedli, J. W. Kolar, “SWISS Rectifier—A Novel Three-Phase Buck-Type PFC Topology for Electric Vehicle Battery Charging”, Proceedings of the 27th Applied Power Electronics Conference and Exposition (APEC 2012), Orlando Fla., USA, Feb. 5-9, 2012, further referred to as ‘[REFERENCE 1]’ introduces an electrical converter that uses the 3^{rd} harmonic active filter principle and that is adapted for single-stage buck-type three-phase PFC AC-to-DC conversion with DC-bus voltage levels that are lower than the full-wave rectified AC voltage, e.g., in the range of 200-400 V. The electrical converter comprises a phase selector for converting a three-phase AC input voltage into intermediate voltages at an upper intermediate node, a lower intermediate node and a middle intermediate node. An output stage with two DC-DC buck circuits converts the intermediate voltages into a DC output voltage. In such existing embodiments the middle intermediate node is connected to the common node of the two DC-DC buck circuits.

A disadvantage of the single-stage buck-type PFC converter based on the 3^{rd} harmonic active filter principle as presented in FIG. 1 of [REFERENCE 1] is that in a practical realization, where a common-mode (L-C) output filter, often containing a coupled capacitive midpoint, is needed to reduce leakage currents to the load and/or to protective earth (PE), quasi lossless zero-voltage-switching (ZVS) of the semiconductor switches cannot be achieved without increasing the cost, size, and complexity of the inductors of the two DC-DC buck circuits (e.g. due to the need for magnetic coupling of these inductors). This is particularly the case when several parallel output stages are used in order to increase the power rating of the converter, and especially when these paralleled output stages are operated in an interleaved fashion in order to decrease the size of the in- and output filters of the PFC converter.

### SUMMARY

It is an objective of embodiments of the present disclosure to provide an improved electrical converter and method for conversion between a three-phase AC signal, e.g. a three-phase AC voltage and a DC signal, e.g. a DC voltage, and in particular for converting a three-phase AC input into a DC output and/or for converting a DC input into a three-phase AC output, and more in particular a low cost electrical converter for three-phase buck-type PFC AC-to-DC conversion. Preferably, embodiments of the electrical converter have one or more of the following advantages: the converter provides the possibility to operate the switching devices under zero-voltage-switching (ZVS) conditions in order to reduce switching losses and increase the efficiency and power density of the converter, even when a common-mode (L-C) output filter with coupled capacitive midpoint is present and/or when interleaving of several parallel output stages is used in order to increase the power rating of the converter and/or decrease the size of the in- and output filters; the converter is simple to design; it is simple to extend the hardware design to an arbitrary number of interleaved stages; the converter has a high power-to-volume ratio (power density) which is enabled by little magnetic energy storage in the electrical converter; the converter generates low current distortions at the three phase terminals; the converter is able to draw substantially sinusoidal currents at the three phase terminals, at a power factor that is substantially equal to one.

According to a first aspect of the present disclosure, there is therefore provided an electrical converter for conversion between a three-phase AC signal and a DC signal, comprising three phase terminals, a first DC terminal and a second DC terminal, a conversion circuitry, a first buck circuit and a second buck circuit. The conversion circuitry is configured for conversion between three phase voltages of the three-phase AC signal provided at the three phase terminals and a first and second intermediate voltage at a first and second intermediate node of the electrical converter. The first buck circuit comprises at least one first switch-node terminal that is operably connected to the first DC terminal and a second buck circuit comprising at least one second switch-node terminal that is operably connected to the second DC terminal. The first and the second buck circuits are connected between the first intermediate node and the second intermediate node for conversion between the first and second intermediate voltage and the three phase voltages, on the one hand, and the DC signal between the first and second DC terminals, on the other hand. The first buck circuit comprises three first devices that are actively switchable for allowing connecting the at least one first switch-node terminal to any one of the three phase terminals, typically three voltage-bidirectional actively switchable devices. The second buck circuit comprises three further first devices that are actively switchable for allowing connecting the at least one second switch-node terminal to any one of the three phase terminals, typically three further voltage-bidirectional actively switchable devices.

Electrical converters feature a conversion circuitry for conversion between a three-phase AC signal with three phase voltages provided at the three phase terminals of the electrical converter and an intermediate signal between the first intermediate node and the second intermediate node. When the conversion is from AC to DC, the electrical converter functions as a rectifier and the conversion circuitry comprises rectifier circuitry, and when the conversion if from DC to AC, the electrical converter functions as an inverter and the conversion circuitry comprises inverter circuitry. The electrical converter further comprises a power stage comprising the first and second buck circuit. By including three first devices and three further first devices in the first and second buck circuit, the phase voltages can be passed to the at least one first and second switch-node terminal in a controlled manner which is in contrast to prior art solutions in which a connection is made between an intermediate middle node created by conversion circuitry implemented as a phase selector and a middle node between the first and second DC terminal, and in particular a direct connection to the common node of the first and second buck circuit, if a common node is present.

In that manner, additional controllability and flexibility is provided for tailoring and optimizing the shape of the currents flowing in the inductors of the first and second buck circuit such that, for example, zero-voltage-switching (ZVS) of the semiconductor switches of the buck circuits can be achieved in the whole operating range of the converter, i.e., without increasing the cost, size, and complexity of the mentioned inductors (e.g. due to the need for magnetic coupling of these inductors in prior art solutions), even when a common-mode (L-C) output filter with coupled capacitive midpoint is present and/or when interleaving of several parallel output stages is used in order to increase the power rating of the converter and/or decrease the size of the in- and output filters. The ability of the converter to operate under zero-voltage-switching conditions within its whole operating range leads to an increased conversion efficiency and/or reduced system size. The latter is the result of a higher switching frequency that can be used, leading to a reduced size of the passive filter elements (inductors and capacitors), without increasing the semiconductor switching losses. Also, the amount of actively switchable devices in a conduction path towards the at least one first switch-node terminal and the at least one second switch-node terminal can be low, as compared to solutions where a conversion circuitry comprising a phase selector is used in combination with a first and second buck circuit.

According to an exemplary embodiment, the first buck circuit comprises at least one second switching device connected between the first intermediate node and the at least one first switch-node terminal, and the second buck circuit comprises at least one further second switching device connected between the second intermediate node and the at least one second switch-node terminal. The at least one second and the at least one further second switching device may be a passively switching device such as a diode or an actively switchable device, typically a current-bidirectional actively switchable device, such as a current-bidirectional transistor, e.g. a MOSFET. When the converter is used to convert a three-phase AC input into a DC output, preferably, the at least one second and further second devices are actively switchable.

The first and second buck circuit advantageously further comprises at least one first filter inductor connected between the at least one first switch-node terminal and the first DC terminal and at least one second filter inductor connected between the at least one second switch-node terminal and the second DC terminal, respectively. Further, at least one filter capacitor may be provided, preferably a series connection of at least two filter capacitors, connected between the first and second DC terminals. The first and second filter inductor and/or the one or more filter capacitors may form a filter with a midpoint. If the first and second buck circuit are connected in series, the common node may be connected to the midpoint.

According to a preferred embodiment, the first and the second buck circuits are connected in series between the first intermediate node and the second intermediate node such that there is a common node of the first and second buck circuit. The first buck circuit may then comprise at least one third device connected between the common node and the at least one first switch-node terminal and the second buck circuit may comprise at least one further third device connected between the common node and the at least one second switch-node terminal. When the first and second buck circuit are connected in series, wherein the at least one third device is connected in series with the three first devices between the common node and the respective phase terminal, and wherein the at least one further third device is connected in series with the three further first devices between the common node and the respective phase terminal, neither the first intermediate node, nor the second intermediate node, nor the three phase terminals are directly connected to the common node of the first and second buck circuit, such that a connection between either the first intermediate node, or the second intermediate node, or the three phase terminals and the common node of the first and second buck circuit can be actively controlled with great flexibility, for example to tailor and optimize the shape of the inductor currents.

According to an alternative embodiment, the first and the second buck circuits are connected in parallel between the first intermediate node and the second intermediate node. The first buck circuit may then comprise at least one third device connected between the second intermediate node and the at least one first switch-node terminal and the second buck circuit may comprise at least one further third device connected between the first intermediate node and the at least one second switch-node terminal. Also, when the first and second buck circuit are connected in parallel, wherein the at least one second device is connected in series with the three first devices between the first intermediate terminal and the respective phase terminal, wherein the at least one further second device is connected in series with the three further first devices between the second intermediate terminal and the respective phase terminal, wherein the at least one third device is connected in series with the three first devices between the second intermediate terminal and the respective phase terminal, and wherein the at least one further third device is connected in series with the three further first devices between the first intermediate terminal and the respective phase terminal, neither the first intermediate node, nor the second intermediate node, nor the three phase terminals are directly connected to a middle node between the first and second DC terminal, such that a connection between either the first intermediate node, or the second intermediate node, or the three phase terminals and a middle node between the first and second DC terminal can be actively controlled with great flexibility, for example to tailor and optimize the shape of the inductor currents.

When the converter is used to convert a DC input into a three-phase AC output, preferably, the at least one third device and the at least one further third device are actively switchable, typically a current-bidirectional actively switchable device. When it is desirable to do conversion in two directions, preferably the second, third, further second, and further third devices are actively switchable, and the devices of the conversion circuitry are also actively switchable, see further. Further, by using devices that are actively switchable, a quasi-lossless zero-voltage switching is possible. This allows for power conversion at lower switching losses, and thus higher energy efficiency. Also, higher switching frequencies may be used in order to increase the power density (reduced size) and reduce the cost of the electrical converter.

According to a preferred embodiment with a common node, the first buck circuit is configured for controlling connections between the at least one first switch-node terminal and the first intermediate node, the three phase terminals, and the common node, and the second buck circuit is configured for controlling connections between the at least one second switch-node terminal and the second intermediate node, the three phase terminals, and the common node. Preferably, the first buck circuit is configured for allowing connecting the at least one first switch-node terminal to any one of the first intermediate node, the three phase terminals, and the common node; and the second buck circuit is configured for allowing connecting the at least one second switch-node terminal to any one of the second intermediate node, the three phase terminals, and the common node. This may be achieved using suitable control signals, typically pulse width modulation signals, for controlling the actively switchable devices of the first and second buck circuit. In other words, depending on the control signals, each first switch-node terminal will either be connected to the first intermediate node, or one of the three phase voltages, or the common node; and each second switch-node terminal will either be connected to the second intermediate node, or one of the three phase voltages, or the common node.

In an exemplary embodiment, the electrical converter may be configured for AC-to-DC conversion, and the three-phase AC signal may be a three-phase AC input voltage and the DC signal may be a DC output voltage having a voltage level that is lower than the full-wave rectified AC input voltage, e.g., in the range of 200-400 V.

According to an exemplary embodiment, the electrical converter comprises a controller configured to control at least one of the conversion circuitry and the first and second buck converter.

Preferably, the controller is configured to control the first buck circuit and the second buck circuit, such that a desired DC output is obtained between the first and the second DC terminal. More in particular, the controller may be configured to control a duty cycle and/or a switching frequency and/or a conduction sequence of control signals used to control the first buck circuit and the second buck circuit, and in particular any actively switchable devices thereof such as the three first devices and the three further first devices. The switching frequency is typically at least 10 times higher than the frequency of the three-phase AC signal. More in particular, the controller may be configured to control a first and second control signal used to control the first buck circuit and the second buck circuit such that the first and second control signals are interleaved.

Preferably, the controller is configured to vary the duty cycle of a control signal for controlling the three first devices and the three further devices such that the respective phase voltages are connected to the at least one first switch-node terminal of the first buck circuit during respective time intervals and to the at least one second switch-node terminal of the second buck circuit during further respective time intervals. More preferably, the controller is configured to control the first and second buck circuits such that the respective time intervals and the further respective time intervals are periodic time intervals covering a period of the three-phase AC signal. When the first and the second buck circuits are connected in series, the controller may be configured such that during each respective time interval, the at least one first switch-node terminal of the first buck circuit is alternately connected to the first intermediate node, the respective phase voltage, and the common node, while the at least one second switch-node terminal of the second buck circuit is alternately connected to the second intermediate node and the common node; and such that during each further respective time interval, the at least one second switch-node terminal of the second buck circuit is alternately connected to the second intermediate node, the respective phase voltage, and the common node, while the at least one first switch-node terminal of the first buck circuit is alternately connected to the first intermediate node and the common node.

The devices mentioned above are preferably semiconductor devices. It is noted that the term “semiconductor device” may refer to a single semiconductor component or a multiple semiconductor components connected in (anti-)parallel and/or in (anti-)series. For example, a semiconductor device which is actively switchable may comprise a transistor connected in anti-parallel with a diode.

In a preferred embodiment, the electrical converter comprises a filter comprising capacitors, typically five capacitors, which interconnect the first intermediate node, the second intermediate node and the three phase terminals, preferably in the form of a “star” connection where each capacitor is connected between a midpoint and one of the first and second intermediate nodes and the three phase terminals, or a “delta” connection, where each capacitor is connected between two of the first and second intermediate nodes and the three phase terminals. When the first and second buck circuits are connected in series and the capacitors are connected in the form of a “star” connection, the capacitors may be connected to the common node.

In a preferred embodiment, the electrical converter comprises measurement means for measuring at least one of the DC signal, an electrical signal influencing the DC signal, an electrical signal influenced by the DC signal. The electrical signal may be a current or a voltage. The controller comprises a control loop configured to adapt at least one of a duty cycle, a switching frequency, and a conduction sequence of control signals for controlling at least one of the first and second buck circuit based on the measurements performed by the measurement means. Typically, the controller comprises a control loop configured to adapt at least one pulse width modulation control signal for controlling at least one of the first and second buck circuit based on the measurements performed by the measurement means. Preferably, the measurement means comprises one or more of the following: a current measurement means for measuring at least one of a current between the first switch-node terminal and the first DC terminal and a current between the second switch-node terminal and the second DC terminal, a voltage measurement means for measuring voltages at the three phase terminals, a voltage measurement means for measuring a voltage between the first and second DC terminal, a current measurement means for measuring a current between the conversion circuitry and at least one of the first and second buck circuit, a voltage measurement means for measuring a voltage of the common node (if a common node is present). Preferably, the control loop is configured to adapt a first pulse width modulation control signal for controlling the first buck circuit and a second pulse width modulation control signal for controlling the second buck circuit. In an advantageous embodiment the controller may be configured to interleave the first and second pulse width modulation control signals.

According to a preferred embodiment, the conversion circuitry comprises three phase legs for interconnecting one of the three phase terminals to any one of the first intermediate node and the second intermediate node, wherein each of the three phase legs comprises a half bridge comprising semiconductor devices. The conversion circuitry may comprise a half-bridge configuration with diodes, typically six diodes. Optionally, the diodes may be replaced with controllable semiconductor devices having bidirectional current flow capabilities. This will allow using the electrical converter both for converting a three-phase AC input into a DC output and for converting a DC output into a three-phase AC input. In other words, such embodiments allow for a bidirectional power flow through the converter.

According to a preferred embodiment, the first and second buck circuits may be scaled, e.g. when more power is needed. When the first and second buck circuit are connected in series, this can be easily done by providing a number of first buck circuit legs or a number of first buck circuits connected in parallel, and by providing a number of second buck circuit legs or a number of second buck circuits connected in parallel. When multiple first buck circuits are connected in parallel, such first buck circuits may be controlled in an interleaved way. The same applies for multiple second buck circuits connected in parallel.

According to a further aspect of the present disclosure, there is provided a battery charging system, in particular for charging a battery of an electric vehicle, comprising a power supply unit, the power supply unit comprising an electrical converter according to any one of the embodiments described above.

According to a further aspect of the present disclosure, there is provided a wireless charging system, in particular for charging a battery of an electric vehicle, comprising a power supply unit, the power supply unit comprising an electrical converter according to any one of the embodiments described above.

According to a further aspect of the present disclosure, there is provided an electric motor drive system, comprising a power supply unit, the power supply unit comprising an electrical converter according to any one of the embodiments described above.

According to a further aspect of the present disclosure, there is provided a gradient amplifier comprising an electrical converter according to any one of the embodiments described above. Also, there is provided a magnetic resonance imaging apparatus comprising the gradient amplifier.

According to yet another aspect, there is provided a method of converting between a three phase AC signal and a DC signal. The method comprises the following steps: converting between a first, second and third phase voltage of the three-phase AC signal and a first and second intermediate voltage, wherein the first intermediate voltage is applied on a first intermediate node and the second intermediate voltage is applied on a second intermediate node, wherein a phase signal of the three-phase AC signal having a highest voltage is continuously applied to the first intermediate node and a phase signal of the three phase AC signal having a lowest voltage is continuously applied to the second intermediate node, and subsequently converting between the first and second intermediate voltages and the first, second and third phase voltages, on the one hand, and the DC signal, on the other hand, using a first and a second buck circuit, wherein the first, second and third phase voltage is intermittently connected to at least one first switch-node terminal of the first buck circuit during respective time intervals and to at least one second switch-node terminal of the second buck circuit during further respective time intervals. The time intervals and the further time intervals may be arranged in any order and may be adjacent or partially overlapping.

Preferably, the first and second buck circuits are controlled such that the respective time intervals and the further respective time intervals are periodic time intervals and such that the respective time intervals and the further respective time intervals cover together a period of the three-phase AC signal.

For example, the respective time intervals may comprise:
a first time interval during which the first phase voltage is intermittently connected to the at least one first switch-node terminal through a first one of the three first devices, whilst the current through said first one of the three first devices rises,
a second time interval during which the third phase voltage is intermittently connected to the at least one first switch-node terminal through a third one of the three first devices, whilst an average current through said third one of the three first devices falls.
a third time interval during which the second phase voltage is intermittently connected to the at least one first switch-node terminal through a second one of the three first devices, whilst an average current through said second one of the three first devices rises,
a fourth time interval during which the first phase voltage is intermittently connected to the at least one first switch-node terminal through said first one of the three first devices, whilst an average current through said first one of the three first devices falls,
a fifth time interval during which the third phase voltage is intermittently connected to the at least one first switch-node terminal through said third one of the three first devices, whilst an average current through said third one of the three first devices rises, and
a sixth time interval during which the second phase voltage is intermittently connected to the at least one first switch-node terminal through said second one of the three first devices, whilst an average current through said second one of the three first devices falls.

Similarly, the further respective time intervals may comprise:
a further first time interval during which the third phase voltage is intermittently connected to the at least one second switch-node terminal through a third one of the three further first devices, whilst an average current through said third one of the three further first devices falls,
a further second time interval during which the second phase voltage is intermittently connected to the at least one second switch-node terminal through a second one of the three further first devices, whilst an average current through said second one of the three further first devices rises,
a further third time interval during which the first phase voltage is intermittently connected to the at least one second switch-node terminal through a first one of the three further first devices, whilst an average current through said first one of the three further first devices falls,
a further fourth time interval during which the third phase voltage is intermittently connected to the at least one second switch-node terminal through said third one of the three further first devices, whilst an average current through said third one of the three further first devices rises,
a further fifth time interval during which the second phase voltage is intermittently connected to the at least one second switch-node terminal through said second one of the three further first devices, whilst an average current through said second one of the three further first devices falls,
a further sixth interval during which the first phase voltage is intermittently connected to the at least one second switch-node terminal through said first one of the three further first devices, whilst an average current through said first one of the three further first devices rises.

The first, second, third, fourth, fifth, and sixth time intervals and the further first, second, third, fourth, fifth, and sixth time intervals may be consecutive time intervals, arranged in any order and may be adjacent or partially overlapping. For example, the order may be: the first time interval, the second time interval, the further first time interval, the further second time interval, the third time interval, the fourth time interval, the further third time interval, the further fourth time interval, the fifth time interval, the sixth time interval, the further fifth time interval, the further sixth time interval.

Preferably, the first and the second buck circuits are connected in series between the first intermediate node and the second intermediate node such that there is a common node (m) of the first and second buck circuit. In such an embodiment, during each respective time interval, the at least one first switch-node terminal of the first buck circuit may be alternately connected to the first intermediate node, the respective first, second, and third phase voltage, and the common node; and during each further respective time interval, the at least one second switch-node terminal of the second buck circuit may be alternately connected to the second intermediate node, the respective first, second, and third phase voltage, and the common node.

Preferably, the converting between the first and second intermediate voltages and the first, second and third phase voltages, on the one hand, and the DC signal, on the other hand, using a first and a second buck circuit comprises controlling at least one of a duty cycle, a switching frequency, a conduction sequence of control signals to control the first and second buck circuit.

Preferably, the converting between the first and second intermediate signals and the first, second and third phase voltages, on the one hand, and the DC signal, on the other hand, using a first and a second buck circuit, comprises using at least one first filter inductor connected between the at least one first switch-node terminal and a first DC terminal and at least one second filter inductor connected between the at least one second switch-node terminal and a second DC terminal, respectively. Preferably, the converting between the first and second intermediate signals and the first, second and third phase voltages, on the one hand, and the DC signal, on the other hand, using a first and a second buck circuit, comprises using at least one filter capacitor, preferably a series connection of at least two filter capacitors, connected between the first and second DC terminals.

Preferably, the converting between the first and second intermediate signals and the first, second and third phase voltages, on the one hand, and the DC signal, on the other hand, is controlled by measuring at least one of the DC signal, an electrical signal influencing the DC signal, an electrical signal influenced by the DC signal, and by adapting at least one of a duty cycle, a switching frequency and a conduction sequence of control signals for controlling the first and/or second buck circuit based on the measured signals. The DC signal is available between a first DC terminal and a second DC terminal. The measuring may comprise measuring one or more of the following: at least one of a current between the first switch-node terminal and the first DC terminal and a current between the second switch-node terminal and the second DC terminal, at least one of the first, second and third phase voltages, a voltage between the first and second DC terminal, at least one of a current between the first intermediate node and the first buck circuit and a current between the second intermediate node and the second buck circuit, a voltage of the common node (if a common node is present). The adapting may comprise adapting at least one first pulse width modulation control signal for controlling the first buck circuit and at least one second pulse width modulation control signal for controlling the second buck circuit.

Methods as described herein are preferably applied for operating the electrical converter as described herein. Preferred features and technical advantages of the embodiments of the electrical converter apply mutatis mutandis for the embodiments of the method.

### BRIEF DESCRIPTION OF THE DRAWINGS

The accompanying drawings are used to illustrate presently preferred non-limiting exemplary embodiments of devices of the present disclosure. The above and other advantages of the features and objects of the disclosure will become more apparent and the present disclosure will be better understood from the following detailed description when read in conjunction with the accompanying drawings, in which:

FIG. 1 is a circuit diagram of an exemplary embodiment of an electrical converter;

FIGS. 2A-2L illustrate various charts plotting various voltages, currents and control signals in function of cot)(° for the exemplary embodiment of FIG. 1;

FIG. 3 illustrates various charts plotting various control signals, voltages, currents and control signals in function of time (microseconds), when ωt=40°, see reference numeral III in FIGS. 2A-2L;

FIG. 4 illustrates various charts plotting various control signals, voltages, currents and control signals in function of time (microseconds), when ωt=60°, see reference numeral IV in FIGS. 2A-2L;

FIG. 5 illustrates various charts plotting various control signals, voltages, currents and control signals in function of time (microseconds), when ωt=80°, see reference numeral V in FIGS. 2A-2L;

FIGS. 6 and 7 illustrate various charts plotting various currents in function of cot)(° for the exemplary embodiment of FIG. 1;

FIGS. 8-11 are circuit diagrams of other exemplary embodiments of an electrical converter;

FIG. 12 illustrates schematically an exemplary embodiment of a control unit;

FIG. 13 is a circuit diagram of another exemplary embodiment of an electrical converter wherein the first circuit and the second buck circuit are connected in parallel.

### DETAILED DESCRIPTION

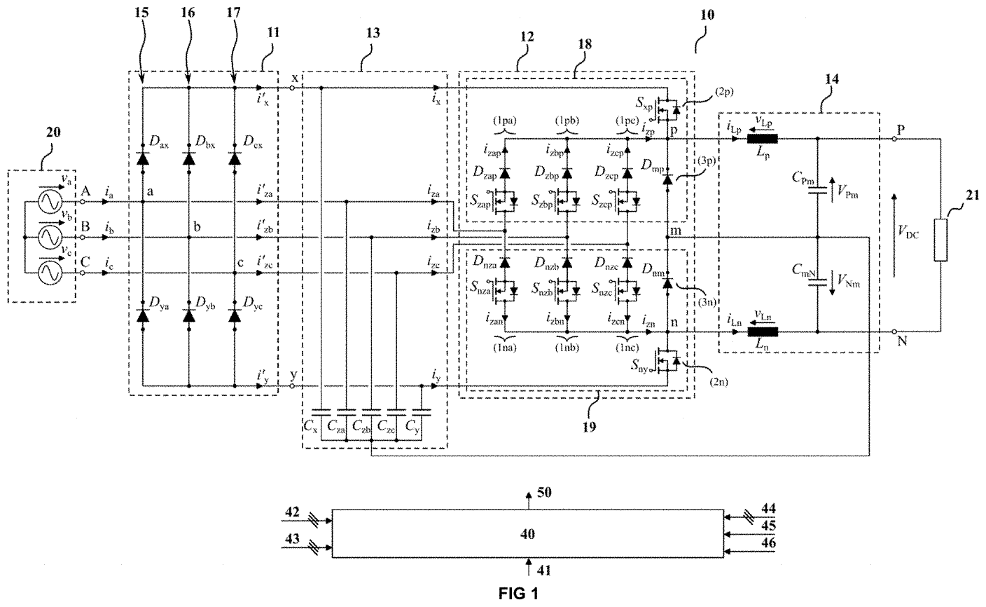

FIG. 1 shows an electrical converter 10, referred to as the ‘PRODRIVE-DIRECT RECTIFIER’, comprising two power stages 11, 12 in the form of a three-phase passive rectifier 11 and an active output power stage 12. Electrical converter 10 further comprises an input filter 13 placed between the passive rectifier 11 and the output power stage 12, and an output filter 14.

The electrical converter 10 is an AC-to-DC converter that has three phase terminals A, B, C which are connected to a three-phase voltage of a three-phase AC grid 20, and a first and second output DC terminal P, N, here an upper output terminal P and a lower output terminal N, which for example may be connected to a DC load 21 such as, for example, a high voltage (e.g. 200-400 V) battery of an electric car. The three-phase rectifier 11 comprises three phase connections a, b, c that are connected to the three phase terminals A, B, C, and two outputs x, y. These outputs x, y correspond with a first intermediate node x, here an upper intermediate voltage node x, and a second intermediate node y, here a lower intermediate voltage node y.

The three-phase passive rectifier 11 comprises, or consists of, three bridge legs 15, 16, 17 which each comprise two passive semiconductor devices (diodes Dₐₓ and D_{ya} for leg 15, D_{bx} and D_{yb} for leg 16, D_{cx} and D_{yc} for leg 17) connected in the form of a half bridge configuration.

The output power stage 12 comprises, or consists of, two stacked (i.e. series connected) buck bridge legs 18, 19 of first and second stacked buck circuits. The first upper buck bridge leg 18 comprises three first semiconductor devices 1pa, 1pb, 1pc, a second semiconductor device 2p and a third semiconductor device 3p. The second lower buck bridge leg 19 comprises a three further first semiconductor devices 1na, 1nb, 1nc, a further second semiconductor device 2n and a further third semiconductor device 3n. The second and further second semiconductor device 2p, 2n is a buck switch (Sₓₚ for the upper buck bridge leg 18 and S_{ny} for the lower buck bridge leg 19). The switches Sₓₚ and S_{ny} of the buck bridge legs 18, 19 are actively switchable semiconductor devices, for example MOSFETs. The third and further third semiconductor device 3p, 3n is a buck diode (Dₘₚ for the upper buck bridge leg 18 and Dₙₘ for the lower buck bridge leg 19). The second and third semiconductor devices 2p, 3p and the further second and further third semiconductor devices 2n, 3n are connected in a half-bridge configuration. The switched middle node of the upper buck bridge leg 18 forms an upper switch-node terminal p which is connected to output P via a first buck inductor, here an upper buck inductor Lₚ, and the switched middle node of the lower buck bridge leg 19 forms a lower switch-node terminal n which is connected to output N via a second buck inductor, here a lower buck inductor Lₙ.

The common node m of both, stacked, buck bridge legs 18, 19 is connected to the midpoint of the output filter 14 which comprises two output filter capacitors C_{Pm}, C_{mN} that are connected in series between the upper output terminal P and the lower output terminal N.

The three first and further first semiconductor devices 1pa, 1pb, 1pc and 1na, 1nb, 1nc are interconnection switches S_{zap}D_{zap}, S_{zbp}D_{zbp}, S_{zcp}D_{zcp} for the first upper buck bridge leg 18 and S_{nza}D_{nza}, S_{nzb}D_{nzb}, S_{nzc}D_{nzc}, for the second lower buck bridge leg 19, with bi-directional voltage blocking capability, which allow for connecting the switched middle node of the respective bridge, i.e., the upper switch-node terminal p for the upper buck bridge leg 18 and the lower switch-node terminal n for the lower buck bridge leg 19, with each of the three phase connections a, b, c. Each interconnection switch S_{zap}D_{zap}, S_{zbp}D_{zbp}, S_{zcp}D_{zcp} of the upper buck bridge leg 18 comprises an actively switchable semiconductor device S_{zap}, S_{zbp}, S_{zcp} connected in anti-series with a diode D_{zap}, D_{zbp}, D_{zbp}, creating a voltage bi-directional interconnection switch. Each interconnection switch S_{nza}D_{nza}, S_{nzb}D_{nzb}, S_{nzc}D_{nzc}, of the lower buck bridge leg 19 comprises an actively switchable semiconductor device S_{nza}, S_{nzb}, S_{nzc} connected in anti-series with a diode D_{nza}, D_{nzb}, D_{nzc}, creating a voltage bi-directional, interconnection switch. Each switchable semiconductor device is advantageously complemented by an anti-parallel diode. In this example, Metal Oxide Field Effect Transistors (MOSFETs) are used for the actively switchable semiconductor devices, each including an internal anti-parallel body diode that may replace an external anti-parallel diode.

The upper buck bridge leg 18 is connected between the upper intermediate voltage node x and the common node m, and is arranged in a way that current can flow from the upper intermediate voltage node x to the upper output terminal P via the switch Sₓₚ when the switch Sₓₚ is closed (conducting, on state), current can flow from a phase connection a, b, c to the upper output terminal P via the corresponding interconnection switch S_{zap}D_{zap}, S_{zbp}D_{zbp}, S_{zcp}D_{zcp} when the corresponding switch S_{zap}, S_{zbp}, S_{zcp} is closed (conducting, on state) and the two remaining (non-corresponding) switches S_{zap}, S_{zbp}, S_{zcp} are open (non-conducting, off state) and the switch Sₓₚ is open (not conducting, off state), and current can flow from the common node m to the upper output terminal P via the diode Dₘₚ when the switches Sₓₚ and S_{zap}, S_{zbp}, S_{zcp} are open (not conducting, off state). The switches Sₓₚ and S_{zap}, S_{zbp}, S_{zcp} of the buck bridge leg 18 are actively switchable semiconductor devices, for example MOSFETs.

The lower buck bridge leg 19 is connected between the common node m and the lower intermediate voltage node y, and is arranged in a way that current can flow from the lower output terminal N to the lower intermediate voltage node y via the switch S_{ny}, when the switch S_{ny} is closed (conducting, on state), current can flow from the lower output terminal N to a phase connection a, b, c via the corresponding interconnection switch S_{nza}D_{nza}, S_{nzb}D_{nzb}, S_{nzc}D_{nzc} when the corresponding switch S_{nza}, S_{nzb}, S_{nzc} is closed (conducting, on state) and the two remaining (non-corresponding) switches S_{nza}, S_{nzb}, S_{nzc} are open (not conducting, off state) and the switch S_{ny} is open (not conducting, off state), and current can flow from the lower output terminal N to the common node m via the diode Dₙₘ when the switches S_{ny} and S_{nza}, S_{nzb}, S_{nzc} are open (not conducting, off state). The switches S_{ny} and S_{nza}, S_{nzb}, S_{nzc} of the buck bridge leg 19 are actively switchable semiconductor devices, for example MOSFETs.

Advantageously, five high-frequency (HF) filter capacitors Cₓ, C_{y}, C_{za}, C_{zb}, C_{zc}, which are part of the input filter 13, are interconnecting the intermediate voltage nodes x and y and the three phase connections a, b, and c in the form of a “star”-connection. Advantageously, the star point of the five high-frequency (HF) filter capacitors Cₓ, C_{y}, C_{za}, C_{zb}, C_{zc} is connected to the common node m of both buck bridge legs 18, 19, and to the midpoint of the output filter 14.

The bridge leg of the passive rectifier 11 that is connected with the phase terminal A, B, or C that has the highest voltage of the three-phase AC input voltage is switched in a way that the corresponding phase terminal A, B, or C is connected to the upper intermediate voltage node x. To achieve this, the bridge leg connects the corresponding phase connection a, b, or c with the upper intermediate voltage node x via the upper diode (Dₐₓ, D_{bx}, D_{cx}) of the bridge leg. The bridge leg of the passive rectifier 11 that is connected with the phase terminal A, B, or C that has the lowest voltage of the three-phase AC input voltage is switched in a way that the corresponding phase terminal A, B, or C is connected to the lower intermediate voltage node y. To achieve this, the bridge leg connects the corresponding phase connection a, b, or c with the lower intermediate voltage node y via the lower diode (D_{ya}, D_{yb}, D_{yc}) of the bridge leg.

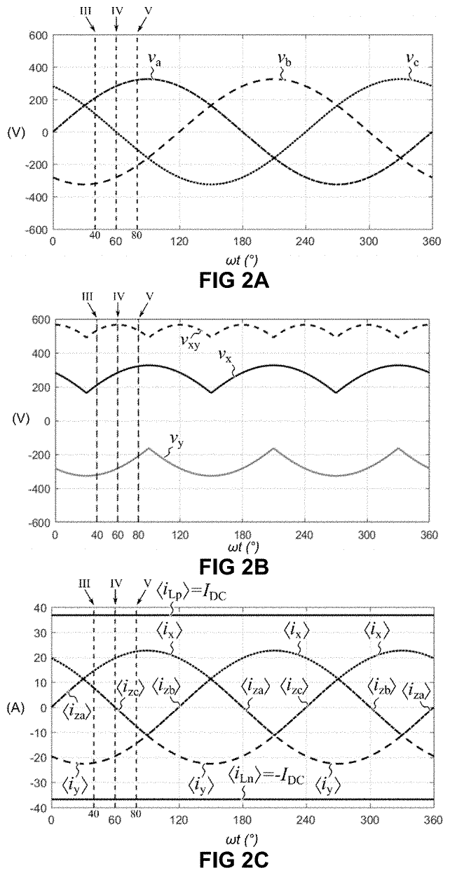

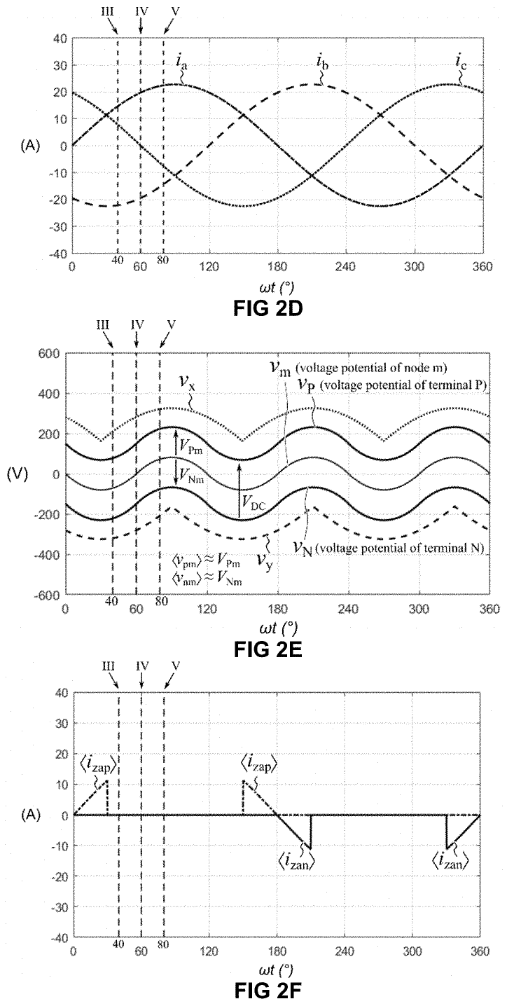

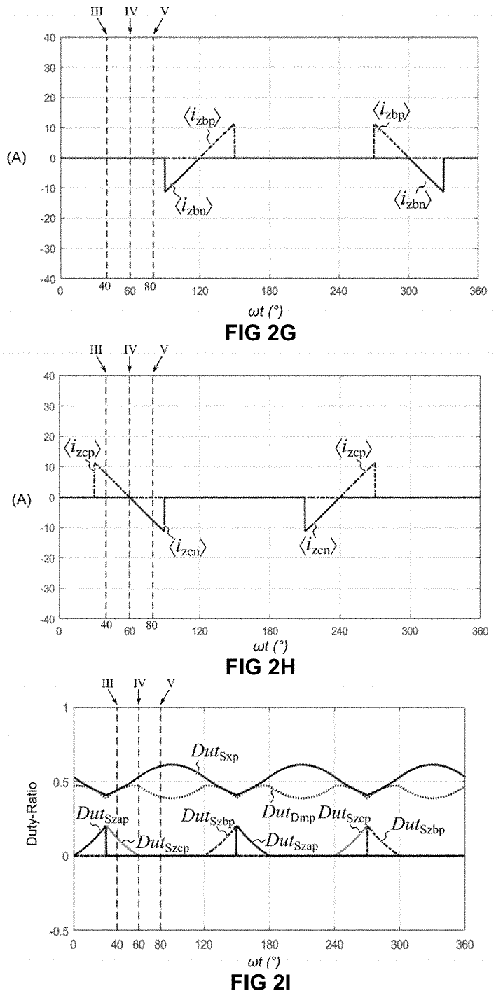

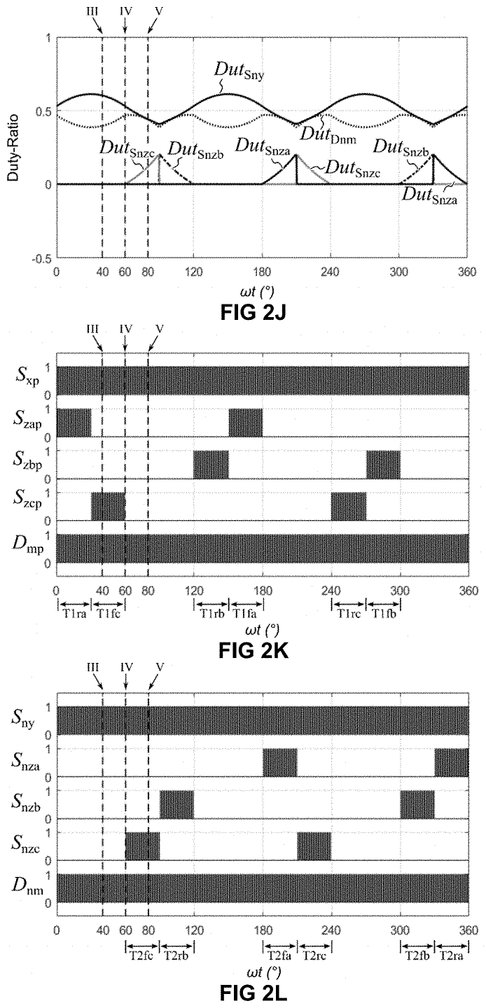

In a three-phase AC grid with substantially balanced phase voltages vₐ, v_{b}, v_{c}, for example as shown in FIG. 2A, the three-phase AC input voltage (mains voltage) is converted into an intermediate DC voltage v_{xy} which is shown in FIG. 2B and which is provided between the upper intermediate voltage node x and the lower intermediate voltage node y. This DC voltage is thus a line-rectified voltage showing piece-wise sinusoidal shapes. The conversion of the three-phase AC input voltage into an intermediate DC voltage is the result of the operation of the passive rectifier 11, as explained above. The diodes of the passive rectifier 11 are ‘conducting’ or ‘not conducting’ during whole particular sectors within the period (360°) of the AC mains voltage (360° corresponds with a time period of 20 ms for a 50 Hz grid frequency; also called a line cycle). Referring to FIG. 2A:
diode Dₐₓ conducts within 30°≤ωt<150°,
diode D_{bx} conducts within 150°≤ωt<270°,
diode D_{cx} conducts within 270°≤ωt<360° and 0°≤ωt<30°,
diode D_{ya} conducts within 210°≤ωt<330°,
diode D_{yb} conducts within 330°≤ωt<360° and 0°≤ωt<90°,
diode D_{yc} conducts within 90°≤ωt<210°,

The combination of states (conducting/not conducting) of the diodes is unique for every 60° sector of the three-phase AC input voltage and depends on the voltage value of the phase terminals A, B, C. The sequence of the 6 unique states of the switches and diodes repeats itself every period (360°) of the AC mains voltage.

Seen from the viewpoint of the intermediate voltage nodes x and y towards the output terminals P, N, a DC-DC buck circuit (upper buck circuit) can be identified, having five input ports x, a, b, c, m and two output ports P, m, and comprising the HF filter capacitors Cₓ, C_{za}, C_{zb}, C_{zc}, the upper buck bridge leg 18, the upper buck inductor Lₚ, and the upper output capacitor C_{Pm}. The voltage between input ports x and m of this upper buck circuit is the voltage v_{Cx}=vₓ−vₘ (vₓ and vₘ are shown in FIG. 2E) across capacitor Cₓ, the voltage between each of the input ports a, b, c and input port m of this upper buck circuit are the voltages (in vector notation) [v_{Cza}, v_{Czb}, v_{Czc}]=[vₐ, v_{b}, v_{c}]-[vₘ, vₘ, vₘ] (vₐ, v_{b}, v_{c} are shown in FIG. 2A and vₘ is shown in FIG. 2E) across capacitors C_{za}, C_{zb}, C_{zc}, and the voltage between output ports P and m of this upper buck circuit is the voltage V_{Pm}=vₚ−vₘ (vₚ and vₘ are shown in FIG. 2E) across the upper output capacitor C_{Pm}. V_{Pm} has a voltage value that is substantially equal to half the total DC bus voltage (V_{Pm}≈V_{DC}/2).

Seen from the viewpoint of the intermediate voltage nodes x and y towards the output terminals P, N, an ‘inversed’ (negative input voltage and negative output voltage) DC-DC buck circuit (lower buck circuit) can be identified, having five input ports y, a, b, c, m and two output ports N, m, and comprising the HF filter capacitors C_{y}, C_{za}, C_{zb}, C_{zc}, the lower buck bridge leg 19, the lower buck inductor Lᵢ and the lower output capacitor C_{mN}. The voltage between input ports y and m of this lower buck circuit is the voltage v_{Cy}=v_{y}−vₘ (v_{y} and vₘ are shown in FIG. 2E) across capacitor C_{y}, the voltage between each of the input ports a, b, c and node m of this lower buck circuit are the voltages (in vector notation) [v_{Cza}, v_{Czb}, v_{Czc}]=[vₐ, v_{b}, v_{c}]−[vₘ, vₘ, vₘ] (vₐ, v_{b}, v_{c} are shown in FIG. 2A and vₘ is shown in FIG. 2E) across capacitors C_{za}, C_{zb}, C_{zc}, and the voltage between output ports N and m of this lower buck circuit is the voltage V_{Nm}=v_{N}−vₘ (v_{N} and vₘ are shown in FIG. 2E) across the lower output capacitor C_{mN}. V_{Nm} has a voltage value that is substantially equal to minus half the total DC bus voltage (V_{Nm}≈−V_{DC}/2).

By PWM modulation (pulse-width-modulation) of the control signals of switches Sₓₚ, and S_{zap}, S_{zbp}, S_{zcp} of the upper buck circuit at a specified, possibly variable, switching frequency fₛ, the upper switch-node terminal p of the upper buck bridge leg 18 can be alternately connected to the upper intermediate voltage node x, to one or more of the three phase connections (in practice one out of the three at a time as otherwise the phases are short-circuited) a, b, c, or to the common node m. This results in a switched voltage vₚₘ between nodes p and m, the switched voltage vₚₘ which may thus have multiple voltage levels. The duty cycles (i.e. the relative on-time within a switching period Tₛ=1/fₛ) of the PWM-modulated control signals of the switches Sₓₚ and S_{zap}, S_{zbp}, S_{zcp} define the average value (vₚₘ) of voltage vₚₘ within a switching period. Control of these duty cycles, and thus also control of the switching-cycle-averaged value [symbol] vₚₘ [symbol] , allows to control the switching-cycle-averaged value [symbol] i_{Lp} [symbol] of the current i_{Lp} in the upper buck inductor Lₚ, e.g. using a closed-loop PI (Proportional-Integrating) control structure. Additionally, control of these duty cycles allows to control the switching-cycle-averaged values [symbol] iₓ [symbol] and/or [symbol] i_{zap} [symbol] , [symbol] i_{zbp} [symbol] , [symbol] i_{zcp} [symbol] of input currents iₓ and i_{zap}, i_{zbp}, i_{zcp}, of the upper buck bridge leg 18 by directing the inductor current i_{Lp} to flow through Sₓₚ (=iₓ) for a certain amount of time (i.e. during the on-interval of Sₓₚ), and/or through S_{zap}D_{zap} (=i_{zap}) for a certain amount of time (i.e. during the on-interval of S_{zap}), and/or through S_{zbp}D_{zbp} (=i_{zbp}) for a certain amount of time (i.e. during the on-interval of S_{zbp}), and/or through S_{zcp}D_{zcp} (=i_{zcp}) for a certain amount of time (i.e. during the on-interval of S_{zcp}).

By PWM modulation (pulse-width-modulation) of the control signals of switches S_{ny} and S_{nza}, S_{nzb}, S_{nzc} of the lower buck circuit at a specified, possibly variable, switching frequency fₛ, the lower switch-node terminal node n of the lower buck bridge leg 19 can be alternately connected to the lower intermediate voltage node y, to one or more of the three-phase input voltage nodes (in practice one out of the three at a time as otherwise the phases are short-circuited) a, b, c, or to the common node m. This results in a switched voltage vₙₘ, between nodes m and n, the switched voltage vₙₘ which may thus have multiple voltage levels. The duty cycles (i.e. the relative on-time within a switching period Tₛ=1/fₛ) of the PWM-modulated control signals of the switches S_{ny} and S_{nza}, S_{nzb}, S_{nzc} define the average value (vₙₘ) of voltage vₙₘ, within a switching period. Control of these duty cycles, and thus also control of the switching-cycle-averaged value [symbol] vₙₘ [symbol] , allows to control the switching-cycle-averaged value [symbol] i_{Ln} [symbol] of the current i_{Ln} in the lower buck inductor L_{N}, e.g. using a closed-loop PI (Proportional-Integrating) control structure. Additionally, control of these duty cycles allows to control the switching-cycle-averaged values [symbol] i_{y} [symbol] and/or [symbol] i_{zan} [symbol] , [symbol] i_{zbn} [symbol] , [symbol] i_{zcn} [symbol] of input currents i_{y} and i_{zan}, i_{zbn}, i_{zcn} of the lower buck bridge leg 19 by directing the inductor current i_{Ln} to flow through S_{ny} (=i_{y}) for a certain amount of time (i.e. during the on-interval of S_{ny}), and/or through D_{nza}S_{nza} (=i_{zan}) for a certain amount of time (i.e. during the on-interval of S_{nza}), and/or through D_{nzb}S_{nzb} (=i_{zbn}) for a certain amount of time (i.e. during the on-interval of S_{nzb}), and/or through D_{nzc}S_{nzc} (=i_{zcn}) for a certain amount of time (i.e. during the on-interval of S_{nzc}).

The current i_{za} is equal to the sum of the current i_{zap} of the upper buck circuit and the current i_{zan} of the lower buck circuit (i_{za}=i_{zap}+i_{zan}), which is also true for the switching-cycle-averaged values of these currents ( [symbol] i_{za} [symbol] = [symbol] i_{zap} [symbol] [symbol] i_{zan} [symbol] ). The current i_{zb} is equal to the sum of the current i_{zbp} of the upper buck circuit and the current i_{zbn} of the lower buck circuit (i_{zb}=i_{zbp}+i_{zbn}), which is also true for the switching-cycle-averaged values of these currents ( [symbol] i_{zb} [symbol] = [symbol] i_{zbp} [symbol] + [symbol] i_{zbn} [symbol] ). The current i_{zc} is equal to the sum of the current i_{zcp} of the upper buck circuit and the current i_{zcn} of the lower buck circuit (i_{zc}=i_{zcp}+i_{zcn}), which is also true for the switching-cycle-averaged values of these currents ( [symbol] i_{zc} [symbol] = [symbol] i_{zcp} [symbol] + [symbol] i_{zcn} [symbol] ).

The internal current i_{zp} of the upper buck circuit is equal to the sum of the internal currents i_{zap}, i_{zbp}, i_{zcp} of the upper buck circuit (i_{zn}=i_{zan}+i_{zbn}+i_{zcn}), which is also true for the switching-cycle-averaged values of these currents ( [symbol] i_{zp} [symbol] = [symbol] i_{zap} [symbol] + [symbol] i_{zbp} [symbol] + [symbol] i_{zcp} [symbol] ). The internal current i_{zn} of the lower buck circuit is equal to the sum of the internal currents i_{zan}, i_{zbn}, i_{zcn} of the lower buck circuit (i_{zn}=i_{zan}+i_{zbn}+i_{zcn}), which is also true for the switching-cycle-averaged values of these currents ( [symbol] i_{zn} [symbol] = [symbol] i_{zan} [symbol] + [symbol] i_{zbn} [symbol] + [symbol] i_{zcn} [symbol] ).

Generally, it can be said that the HF components of currents iₓ, i_{y}, i_{za}, i_{zb}, i_{zc} at the input of the output power stage 12 are largely filtered by HF filter capacitors Cₓ, C_{y}, C_{za}, C_{zb}, C_{zc}. As a result, the currents i′ₓ, i′_{y}, i′_{za}, i′_{zb}, i′_{zc} at the output of the three-phase rectifier 11 are largely equal to the switching-cycle-averaged values [symbol] iₓ [symbol] , [symbol] i_{y} [symbol] , [symbol] i_{za} [symbol] , [symbol] i_{zb} [symbol] , [symbol] i_{zc} [symbol] of currents iₓ, i_{y}, i_{za}, i_{zb}, i_{zc}, i.e., i′ₓ≈ [symbol] iₓ [symbol] , i′_{y}≈ [symbol] i_{y} [symbol] , i′_{za}≈ [symbol] i_{za} [symbol] , i′_{zb}≈ [symbol] i_{zb} [symbol] , i′_{zc}≈ [symbol] i_{zc} [symbol] .

The duty cycles of the PWM control signals of the switches Sₓₚ and S_{zap}, S_{zbp}, S_{zcp} are such that the switching-cycle-averaged value [symbol] vₚₘ [symbol] is substantially equal to half the total DC bus voltage ( [symbol] vₚₘ [symbol] =V_{Pm}≈V_{DC}/2; see FIG. 2E), while the duty cycles of the PWM control signals of the switches S_{ny} and S_{nza}, S_{nzb}, S_{nzc}, are such that the switching-cycle-averaged value [symbol] vₙₘ [symbol] is substantially equal to minus half the total DC bus voltage ( [symbol] vₙₘ [symbol] =V_{Nm}≈−V_{DC}/2; see FIG. 2E). This means that the switching-cycle-averaged voltages (i.e. the volt-seconds products) of both the upper buck inductor Lₚ and the lower buck inductor Lₙ are substantially equal to zero.

An example of the switching-cycle-averaged values [symbol] i_{Lp} [symbol] , [symbol] i_{Ln} [symbol] of currents i_{Lp}, i_{Ln} in the inductors Lₚ, Lₙ is shown in FIG. 2C. As can be seen, current i_{Lp} may be controlled to have a switching-cycle-averaged value equal to a requested DC output current ( [symbol] i_{Lp} [symbol] =I_{DC}) while current i_{Ln} may be controlled to have a switching-cycle-averaged value equal to minus the requested DC output current ( [symbol] i_{Ln} [symbol] =−I_{DC}).

Also shown in FIG. 2C is an example of the switching-cycle-averaged values [symbol] iₓ [symbol] , [symbol] i_{y} [symbol] , [symbol] i_{za} [symbol] , [symbol] i_{zb} [symbol] , [symbol] i_{zc} [symbol] of currents iₓ, i_{y}, i_{za}, i_{zb}, i_{zc} As can be seen, these currents may be controlled to have piece-wise sinusoidal shapes. Current i′ₓ= [symbol] iₓ [symbol] at the output of the passive rectifier 11 is controlled to be in phase with the phase voltage (vₐ, or v_{b}, or v_{c}) that has the highest value of the three-phase AC input voltage (vₐ, v_{b}, v_{c}) and thus has the same piece-wise sinusoidal shape as the highest phase voltage of the three-phase AC input voltage present at phase terminals A, B and C. Current i′_{y}= [symbol] i_{y} [symbol] at the output of the passive rectifier 11 is controlled to be in phase with the phase voltage (vₐ, or v_{b}, or v_{c}) that has the lowest value of the three phase AC input voltages (vₐ, v_{b}, v_{c}) and thus has the same piece-wise sinusoidal shape as the lowest phase voltage of the three-phase AC input voltage present at phase terminals A, B and C. Currents i′_{za}= [symbol] i_{za} [symbol] , i′_{zb}= [symbol] i_{zb} [symbol] , i′_{zc}= [symbol] i_{zc} [symbol] at the output of the passive rectifier 11 are controlled to be in phase with the corresponding phase voltage (respectively vₐ, v_{b}, v_{c}) when the corresponding phase voltage (respectively vₐ, v_{b}, v_{c}) has a voltage value between the highest voltage and the lowest voltage of the three-phase AC input voltage (vₐ, v_{b}, v_{c}) and are controlled to be zero when the corresponding phase voltage (respectively vₐ, v_{b}, v_{c}) has the highest or lowest voltage value of the three phase AC input voltage (vₐ, v_{b}, v_{c}). Currents i′_{za}= [symbol] i_{za} [symbol] , i′_{zb}= [symbol] i_{zb} [symbol] , i′_{zc}= [symbol] i_{zc} [symbol] thus have the same piece-wise sinusoidal shape as the voltage of their corresponding phase voltage (respectively vₐ, v_{b}, v_{c}) when that phase voltage is between the highest voltage and the lowest voltage of the three-phase AC input voltage (vₐ, v_{b}, v_{c}). The currents i′ₓ, i′_{y}, i′_{za}, i′_{zb}, i′_{zc} are transformed, i.e., as a result of the operation of the passive rectifier 11, into three sinusoidal AC phase currents iₐ, i_{b}, i_{c} which are shown in FIG. 2D, realizing Power Factor Correction (PFC) operation of the electrical converter 10.

FIG. 2I shows examples of the duty cycles (with duty cycle Dut: 0≤Dut≤1, where Dut=0 means continuously ‘off’ within a switching period Tₛ and Dut=1 means continuously ‘on’ within a switching period Tₛ) of the switches and diodes (Sₓₚ, S_{zap}, S_{zbp}, S_{zcp}, Dₘₚ) of the upper buck bridge leg 18 and FIG. 2J shows the duty cycles of the switches and diodes (S_{ny}, S_{nza}, S_{nzb}, S_{nzc}, Dₙₘ) of the lower buck bridge leg 19. These duty cycles correspond with the examples of FIGS. 2A-2H.

As can be seen from FIG. 2J, the duty cycle of the control signal of switch S_{nza} equals zero during certain intervals within the line cycle of the mains voltage, i.e., in these intervals the switch S_{nza} is continuously open (not conducting). Conform FIG. 2A this is the case for the intervals where vₐ>[v_{b}, v_{c}] or vₐ<[v_{b}, v_{c}] or vₐ>[0]. This means that the current i_{zan} (and its switching-cycle-averaged value (i_{zan})) is zero during these intervals, resulting in i′_{za}= [symbol] i_{za} [symbol] = [symbol] i_{zap} [symbol] during these intervals, as can also be seen from FIGS. 2C, 2F. Similarly, and as can be seen from FIG. 2I, the duty cycle of the control signal of switch S_{zap} equals zero during certain intervals within the line cycle of the mains voltage, i.e., in these intervals the switch S_{zap} is continuously open (not conducting). Conform FIG. 2A this is the case for the intervals where vₐ>[v_{b}, v_{c}] or vₐ<[v_{b}, v_{c}] or vₐ<[0]. This means that the current i_{zap} (and its switching-cycle-averaged value (i_{zap})) is zero during these intervals, resulting in i′_{za}= [symbol] i_{za} [symbol] = [symbol] i_{zan} [symbol] during these intervals, as can also be seen from FIGS. 2C, 2F. Following the same reasoning for switches S_{nzb}, S_{zbp} and for switches S_{ncz}, S_{zcp}, and conform FIGS. 2A, 2I, 2J, the intervals within the line cycle of the mains voltage where the respective interconnection switches are continuously open (not conducting; duty cycle equal to zero) are:
Dut_{Szap}=0 for vₐ>[v_{b}, v_{c}] or vₐ<[v_{b}, v_{c}] or vₐ<[0],
Dut_{Snza}=0 for vₐ>[v_{b}, v_{c}] or vₐ<[v_{b}, v_{c}] or vₐ>[0],
Dut_{Szbp}=0 for v_{b}>[vₐ, v_{c}] or v_{b}<[vₐ, v_{c}] or v_{b}<[0],
Dut_{Spzb}=0 for v_{b}>[vₐ, v_{c}] or v_{b}<[vₐ, v_{c}] or v_{b}>[0],
Dut_{Szcp}=0 for v_{c}>[vₐ, v_{b}] or v_{c}<[vₐ, v_{b}] or v_{c}<[0],
Dut_{Snzc}=0 for v_{c}>[vₐ, v_{b}] or v_{c}<[vₐ, v_{b}] or v_{c}>[0].

FIG. 2K shows the states of the switches Sₓₚ, S_{zap}, S_{zbp}, S_{zcp} of the upper buck bridge leg 18, and FIG. 2L shows the states of the switches S_{ny}, S_{nza}, S_{nzb}, S_{nzc} of the lower buck bridge leg 19, within a line cycle of the mains voltage. The switches Sₓₚ, S_{zap}, S_{zbp}, S_{zcp}, S_{ny}, S_{nza}, S_{nzb}, S_{nzc} are all PWM modulated at a frequency (i.e. the switching frequency fₛ; e.g. 100 kHz) that is substantially higher than the mains frequency (e.g. 50 Hz), as can be seen from the black-colored bars, indicating PWM modulation of the corresponding switch. Conform FIGS. 2I, 2J, switches S_{zap}, S_{zbp}, S_{zcp}, S_{nza}, S_{nzb}, S_{nzc} are continuously open (not conducting) during certain intervals of the line cycle as described above.

The control signals shown in FIGS. 2K and 2L allow to intermittently connect the first, second and third phase voltage vₐ, v_{b}, v_{c} to the first switch-node terminal p of the first buck circuit during time intervals T1ra, T1fa, T1rb, T1fb, T1rc, T1fc, and to the second switch-node terminal n of the second buck circuit during further time intervals T2ra, T2fa, T2rb, T2fb, T2rc, T2fc. The time intervals T1ra, T1fa, T1rb, T1fb, T1rc, T1fc and the further time intervals T2ra, T2fa, T2rb, T2fb, T2rc, T2fc may be arranged in any order and may be adjacent, partially overlapping, or fully overlapping.

As illustrated the respective time intervals may comprise:
a first time interval T1ra during which the first phase voltage vₐ is intermittently connected to the first switch-node terminal p through a first one S_{zap} of the three first switches, whilst an average current [symbol] i_{zap} [symbol] through said first one S_{zap} of the three first switches rises (which corresponds with the phase current iₐ which is rising),
a second time interval T1fc during which the third phase voltage v_{c} is intermittently connected to the first switch-node terminal p through a third one S_{zcp} of the three first switches, whilst an average current [symbol] i_{zcp} [symbol] through said third one S_{zcp} of the three first switches falls (which corresponds with the phase current i_{c} which is falling).
a third time interval T1rb during which the second phase voltage v_{b} is intermittently connected to the first switch-node terminal p through a second one S_{zbp} of the three first switches, whilst an average current [symbol] i_{zbp} [symbol] through said second one S_{zbp} of the three first switches rises (which corresponds with the phase current i_{b} which is rising),
a fourth time interval T1fa during which the first phase voltage vₐ is intermittently connected to the first switch-node terminal p through said first one S_{zap} of the three first switches, whilst an average current [symbol] i_{zap} [symbol] through said first one S_{zap} of the three first switches falls (which corresponds with the phase current i_{b} which is falling),
a fifth time interval T1rc during which the third phase voltage v_{c} is intermittently connected to the first switch-node terminal p through said third one S_{zcp} of the three first switches, whilst an average current [symbol] i_{zcp} [symbol] through said third one S_{zcp} of the three first switches rises (which corresponds with the phase current i_{c} which is rising), and
a sixth time interval T1fb during which the second phase voltage v_{b} is intermittently connected to the first switch-node terminal p through said second one S_{zbp} of the three first switches, whilst an average current [symbol] i_{zbp} [symbol] through said second one S_{zbp} of the three first switches falls (which corresponds with the phase current i_{b} which is falling).

Similarly, the further respective time intervals may comprise:
a further first time interval T2fc during which the third phase voltage v_{c} is intermittently connected to the second switch-node terminal n through a third one S_{nzc} of the three further first switches, whilst an average current [symbol] i_{zcn} [symbol] through said third one S_{nzc} of the three further first switches falls (which corresponds with the phase current i_{c} which is falling),
a further second time interval T2rb during which the second phase voltage v_{b} is intermittently connected to the second switch-node terminal n through a second one S_{nzb} of the three further first switches, whilst an average current [symbol] i_{zbn} [symbol] through said second one S_{nzb} of the three further first switches rises (which corresponds with the phase current i_{b} which is rising),
a further third time interval T2fa during which the first phase voltage vₐ is intermittently connected to the second switch-node terminal n through a first one S_{nza} of the three further first switches, whilst an average current [symbol] i_{zan} [symbol] through said first one S_{nza} of the three further first switches falls (which corresponds with the phase current iₐ which is falling),
a further fourth time T2rc interval during which the third phase voltage v_{c} is intermittently connected to the second switch-node terminal n through said third one S_{nzc} of the three further first switches, whilst an average current [symbol] i_{zcn} [symbol] through said third one S_{nzc} of the three further first switches rises (which corresponds with the phase current i_{c} which is rising),
a further fifth time interval T2fb during which the second phase voltage v_{b} is intermittently connected to the second switch-node terminal n through said second one S_{nzb} of the three further first switches, whilst an average current [symbol] i_{zbn} [symbol] through said second one S_{nzb} of the three further first switches falls (which corresponds with the phase current i_{b} which is falling),
a further sixth time interval T2ra during which the first phase voltage vₐ is intermittently connected to the at second switch-node terminal n through said first one S_{nza} of the three further first switches, whilst an average current [symbol] i_{zan} [symbol] through said first one S_{nza} of the three further first switches rises (which corresponds with the phase current iₛ which is rising).

The first, second, third, fourth, fifth, and sixth time intervals T1ra, T1fc, T1rb, T1fa, T1rc, T1fb and the further first, second, third, fourth, fifth, and sixth time intervals T2fc, T2rb, T2fa, T2rc, T2fb, T2ra may be consecutive time intervals, arranged in any order and may be adjacent, partially overlapping or fully overlapping. For example, the order may be as illustrated: the first time interval T1ra, the second time interval T1fc, the further first time interval T2fc, the further second time interval T2rb, the third time interval T1rb, the fourth time interval T1fa, the further third time interval T2fa, the further fourth time interval T2rc, the fifth time interval T1rc, the sixth time interval T1fb, the further fifth time interval T2fb, the further sixth time interval T2ra. Together, the first, second, third, fourth, fifth, and sixth time intervals T1ra, T1fc, T1rb, T1fa, T1rc, T1fb and the further first, second, third, fourth, fifth, and sixth time intervals T2fc, T2rb, T2fa, T2rc, T2fb, T2ra cover a period of the three-phase AC signal.

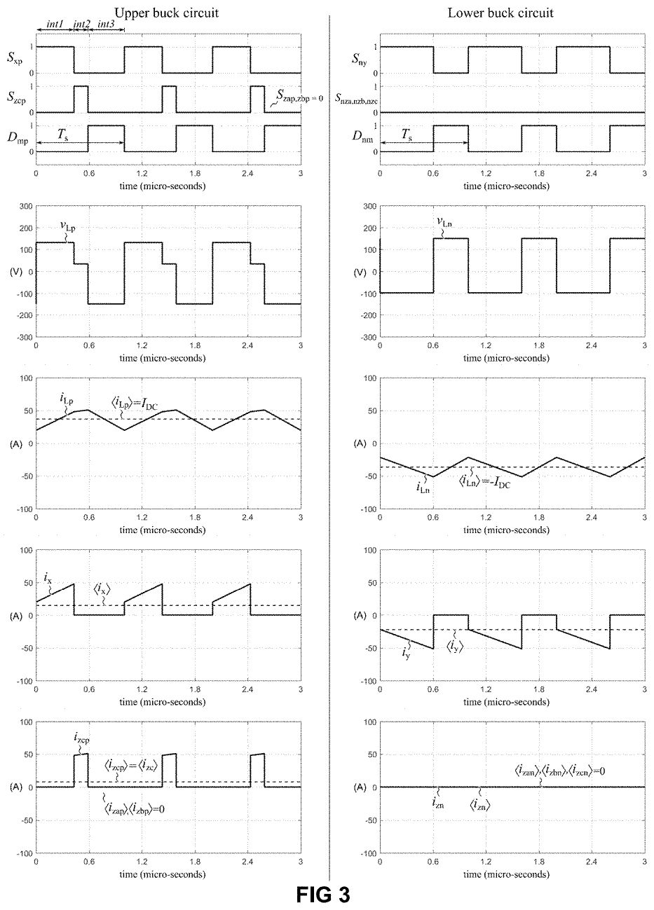

FIGS. 3 and 5, see the detailed discussion below, show that during a respective time interval (in the example of FIG. 3 during T11fc and during T1rc), the upper switch-node terminal p of the first buck circuit may be alternately connected to the upper intermediate node x, the respective phase connection c, and the common node m; and that during a further respective time interval (in the example of FIG. 5 during T2fc and during T2rc), the lower switch-node terminal n of the second buck circuit may be alternately connected to the lower intermediate node y, the respective phase voltage c, and the common node m. In other non-illustrated embodiments where the time intervals fully overlap, one of the first switches S_{zap}, S_{zbp}, S_{zcp} may be switched synchronously with the second switch Sₓₚ. Similarly, one of the further first switches S_{nza}, S_{nzb}, S_{nzc} may be switched synchronously with the second switch S_{ny}.

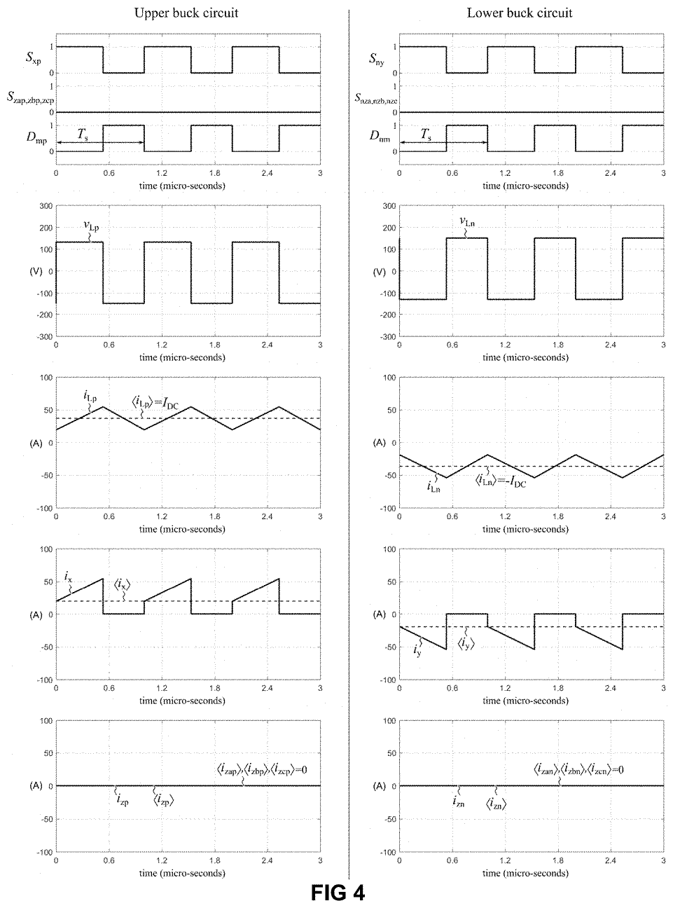

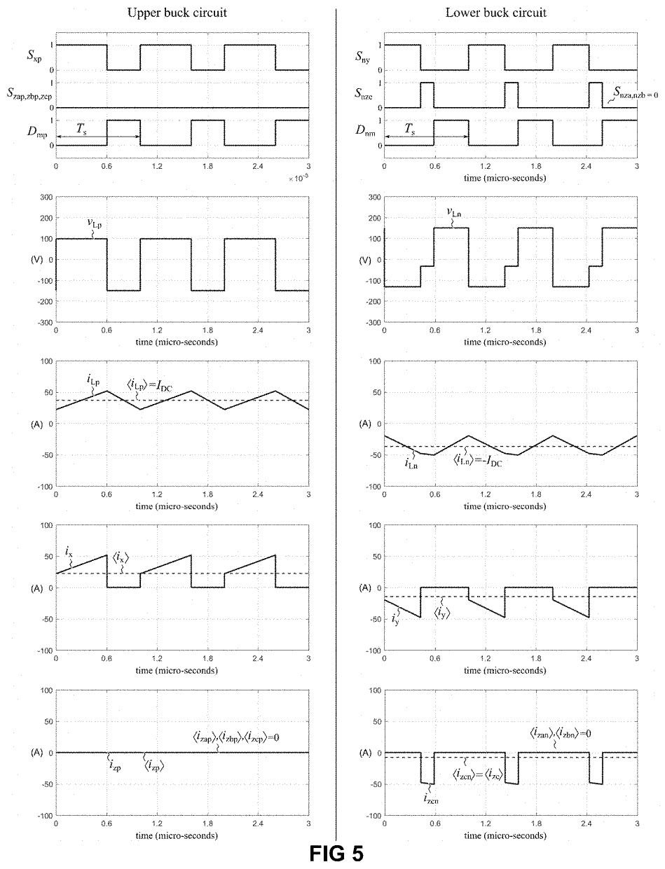

FIGS. 3-5 show diagrams of currents, voltages, and switching signals on a milliseconds time axis, i.e. regarding three consecutive switching cycles of the bridge legs of the output power stage 12 of the electrical converter 10. Each switching cycle has a switching period Tₛ equal to 1/fₛ, with fₛ the switching frequency. FIG. 3 corresponds with a time interval around ωt=40° within the line cycle of the mains voltage (see reference numeral III in FIGS. 2A-2L), FIG. 4 corresponds with a time interval around ωt=60° within the line cycle of the mains voltage (see reference numeral IV in FIGS. 2A-2L), and FIG. 5 corresponds with a time interval around ωt=80° within the line cycle of the mains voltage (see reference numeral V in FIGS. 2A-2L). For all FIGS. 3-5, the diodes of the passive rectifier 11 are in the following switching states:
Diode Dₐₓ=1 (conducting), diode D_{ya}=0 (blocking); phase connection a is connected with node x; and iₐ=i′ₓ;
Diode D_{bx}=0 (blocking), diode D_{yb}=1 (conducting); phase connection b is connected with node y; and i_{b}=i′_{y};
Diode D_{cx}=0 (blocking), diode D_{yc}=0 (blocking); and i_{c}=i′_{zc}.

The left columns (‘upper buck circuit’) of FIGS. 3-5 correspond with the operation of the upper buck circuit, while the right columns (‘lower buck circuit’) of FIGS. 3-5 correspond with the operation of the lower buck circuit. Each of FIGS. 3-5 shows:
the control signals of the switches and diodes (Sₓₚ, S_{zap}, S_{zbp}, S_{zcp}, Dₘₚ) of the PWM-modulated upper buck bridge leg 18, and the control signals of the switches and diodes (S_{ny}, S_{nza}, S_{nzb}, S_{nzc}, Dₙₘ) of the PWM-modulated lower buck bridge leg 19; ‘1’ means ‘on’ and conducting, and ‘0’ means ‘off’ and not conducting; see first rows of FIGS. 3-5,
the voltage v_{Lp} across the upper buck inductor Lₚ and the voltage v_{Ln} across the lower buck inductor Lₙ; see second rows of FIGS. 3-5,
the current i_{Lp} in the upper buck inductor Lₚ (and the switching-cycle-averaged value, [symbol] i_{Lp} [symbol] =I_{DC}, of this current), and the current i_{Ln} in the lower buck inductor Lₙ (and the switching-cycle-averaged value, [symbol] i_{Ln} [symbol] =−I_{DC}, of this current); see third rows of FIGS. 3-5,
the input current iₓ of the upper buck bridge leg 18 (and the switching-cycle-averaged value [symbol] iₓ [symbol] of this current) and the input current i_{y} of the lower buck bridge leg 19 (and the switching-cycle-averaged value [symbol] i_{y} [symbol] of this current); see fourth rows of FIGS. 3-5,
the input currents i_{zap}, i_{zbp}, i_{zcp}, i_{zp} of the upper buck bridge leg 18 (and the switching-cycle-averaged values [symbol] i_{zap} [symbol] , [symbol] i_{zbp} [symbol] , [symbol] i_{zcp} [symbol] , [symbol] i_{zp} [symbol] of these currents) and the input currents i_{nza}, i_{nzb}, i_{nzc}, i_{nz} of the lower buck bridge leg 19 (and the switching-cycle-averaged values [symbol] i_{nza} [symbol] , [symbol] i_{nzb} [symbol] , [symbol] i_{nzc} [symbol] , [symbol] i_{nz} [symbol] of these currents); see fifth rows of FIGS. 3-5.

It is noted that FIG. 3 illustrates a situation where the third phase voltage v_{c} is intermittently connected to the first switch node terminal p by operating the first switch S_{zcp} with a PWM signal, wherein S_{zap}, S_{zbp}=0. The skilled person understands that the operation is similar when the first switch Sₗₐₚ or the first switch S_{zbp} is operated with a PWM signal. Similarly, it is noted that FIG. 5 illustrates a situation where the third phase voltage v_{c} is intermittently connected to the second switch node terminal n by operating the first switch S_{nzc} with a PWM signal, wherein S_{nza}, S_{nzb}=0. The skilled person understands that the operation is similar when the first switch S_{nza} or the first switch S_{nzb} is operated with a PWM signal.

In the regarded time interval of FIG. 3, i.e., around ωt=40° within the line cycle of the mains voltage (see reference numeral III in FIGS. 2A-2L), v_{b}<v_{c}<vₐ, v_{c}>0, i′_{zc}= [symbol] i_{zc} [symbol] = [symbol] i_{zcp} [symbol] , i′_{za}= [symbol] i_{zap} [symbol] = [symbol] i_{zan} [symbol] =0, i′_{zb}= [symbol] i_{zbp} [symbol] = [symbol] i_{zbn} [symbol] =0) (i_{zcn})=0 and i_{zn}=0, i.e., the duty cycle of the control signal of switches S_{nza}, S_{nzb}, S_{nzc}, S_{zap}, S_{zbp} equals zero (continuously open; not conducting).

In the regarded time interval of FIG. 4, i.e., around ωt=60° within the line cycle of the mains voltage (see reference numeral IV in FIGS. 2A-2L), v_{b}<v_{c}<vₐ, v_{c}=0, i_{zp}= [symbol] i_{zp} [symbol] =0, i_{zn}= [symbol] i_{zn} [symbol] =0, i′_{za}= [symbol] i_{zap} [symbol] = [symbol] i_{zan} [symbol] =0, i′_{zb}= [symbol] i_{zbp} [symbol] = [symbol] i_{zbn} [symbol] =0, and i′_{zc}= [symbol] i_{zcp} [symbol] = [symbol] i_{zcn} [symbol] =0 i.e., the duty cycle of the control signals of switches S_{nza}, S_{nzb}, S_{nzc}, S_{zap}, S_{zbp}, S_{zcp} equals zero (continuously open; not conducting).

In the regarded time interval of FIG. 5, i.e., around ωt=80° within the line cycle of the mains voltage (see reference numeral V in FIGS. 2A-2L), v_{b}<v_{c}<vₐ, v_{c}<0, and i′_{zc}= [symbol] i_{zc} [symbol] = [symbol] i_{zcn} [symbol] , i′_{za}= [symbol] i_{zap} [symbol] = [symbol] i_{zan} [symbol] =0, i′_{zb}= [symbol] i_{zbp} [symbol] = [symbol] i_{zbn} [symbol] =0, [symbol] i_{zcp} [symbol] =0 and i_{zn}=0, i.e., the duty cycle of the control signal of switches S_{nzb}, S_{nzc}, S_{zap}, S_{zbp}, S_{zcp} equals zero (continuously open; not conducting).

In FIGS. 3-5, the semiconductor devices (switches and diodes) of the buck bridge legs 18, 19 of the output power stage 12 are sequentially conducting. For example, in FIG. 3 the conduction sequence of the switches and diodes of the PWM-modulated upper buck bridge leg 18 within a switching period Tₛ (=1/L) is as follows:
Interval 1 (int1; see left upper figure inset of FIG. 3): Sₓₚ conducts while S_{zcp} D_{zcp} and Dₘₚ do not conduct,
Interval 2 (int2; see left upper figure inset of FIG. 3): S_{zcp} D_{zcp} conducts while Sₓₚ and Dₘₚ do not conduct,
Interval 3 (int1; see left upper figure inset of FIG. 3): Dₘₚ conducts while Sₓₚ and S_{zcp} D_{zcp} do not conduct.

This sequence repeats itself in the following switching period.

Although not illustrated, the operation of the first and second buck circuit may be interleaved in order to reduce the current stress of the in- and output filter capacitors, enabling a size reduction of the in- and output filters.

Different conduction sequences, possibly including more intervals, may also be used for the buck bridge legs. For example, in FIG. 3 a fourth conduction interval may be added to the conduction sequence of the switches and diodes of the PWM-modulated upper buck bridge leg 18 within a switching period Tₛ (=1/L), which may result in:
Interval 1 (int1′): Sₓₚ conducts while S_{zcp}, D_{zcp} and Dₚₘ do not conduct,
Interval 2 (int2′): S_{zcp}, D_{zcp} conducts while Sₓₚ and Dₚₘ do not conduct,
Interval 3 (int3′): Dₚₘ conducts while Sₓₚ and S_{zcp}, D_{zpc} do not conduct,
Interval 4 (int4′): S_{zcp}, D_{zcp} conducts while Sₓₚ and Dₚₘ do not conduct.

The same holds for the switches and diodes of the PWM-modulated lower buck bridge leg 19.

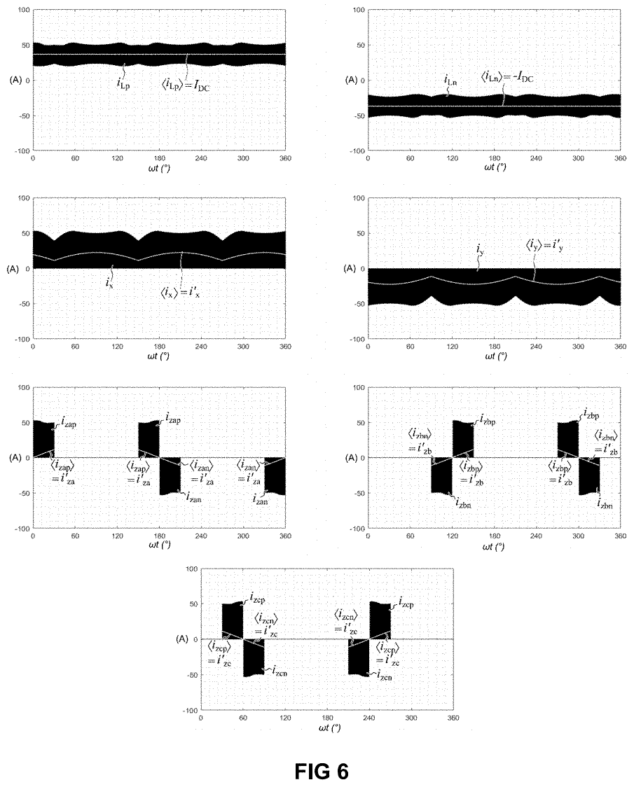

FIG. 6 shows the currents i_{Lp}, i_{Ln}, iₓ, i_{y}, i_{zap}, i_{zbp}, i_{zcp}, i_{zan}, i_{zbn}, i_{zcn} within a whole line cycle (360°) of the mains voltage. Also shown are the switching-cycle-averaged values [symbol] i_{Lp} [symbol] , [symbol] i_{Ln} [symbol] , [symbol] iₓ [symbol] , [symbol] i_{y} [symbol] , [symbol] i_{zap} [symbol] , [symbol] i_{zbp} [symbol] , [symbol] i_{zcp} [symbol] , [symbol] i_{zan} [symbol] , [symbol] i_{zbn} [symbol] , [symbol] i_{zcn} [symbol] of these currents which correspond with the currents shown in FIG. 2C.

An advantage of the electrical converter 10 that is provided by the present disclosure is the integration of the input voltage selector from [REFERENCE 1] into the power stage 12. This allows a reduction of conduction losses as the third-harmonic injection current has less semiconductor devices in the power path. In order to minimize the Total Harmonic Distortion (THD) of the AC input current of the electrical converter, the high-frequency ripple of phase currents iₐ, i_{b}, i_{c} is advantageously minimized, which is taken care of by the input filter 13.

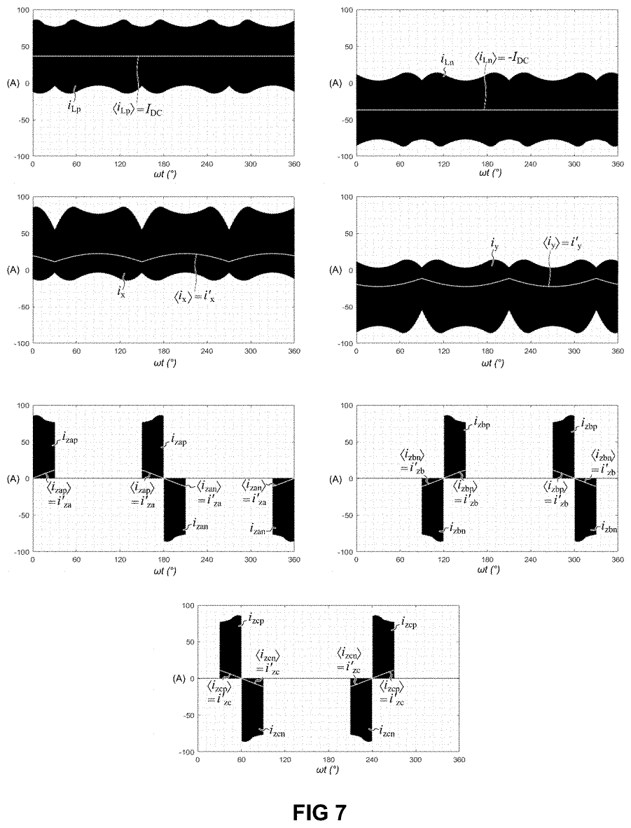

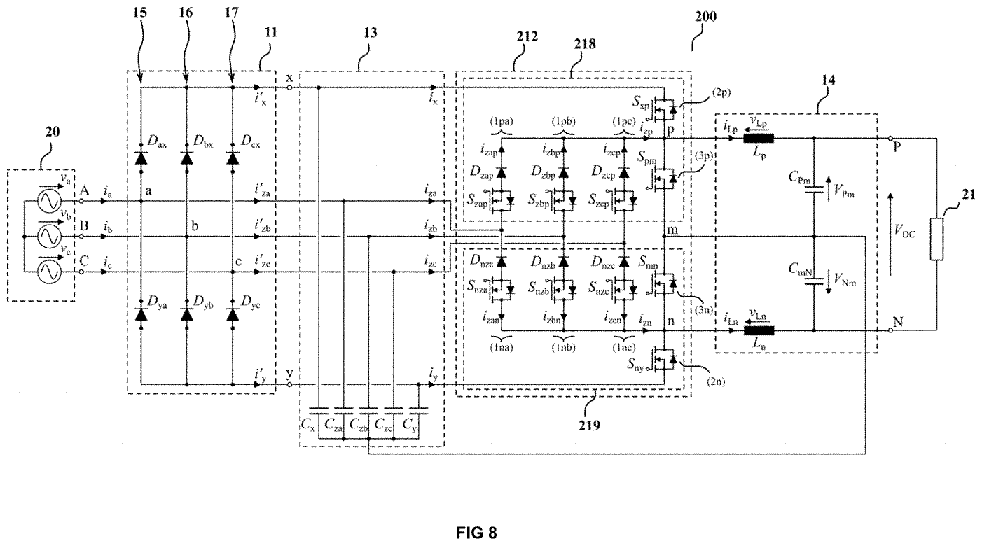

In FIG. 8, an electrical converter 200 is shown which differs from converter 10 in that the diodes Dₘₚ, Dₙₘ of the output power stage 12 of the converter shown in FIG. 1 have been replaced with controllable semiconductor switches (Sₚₘ, Sₙᵢₚ), in this case MOSFETs, in the output power stage 212. This allows for the inductor current (i_{Lp}) to also become negative within the conduction interval of Sₚₘ and for the inductor current (i_{Ln}) to also become positive within the conduction interval of Sₘₙ, which was not possible for the implementation of the output power stage 12 with diodes (Dₘₚ, Dₙₘ). As a result, quasi-lossless zero-voltage switching (ZVS) or zero-current switching (ZCS) of all the semiconductor switches Sₓₚ, S_{zap}, S_{zbp}, S_{zcp}, Sₚₘ, S_{ny}, S_{nza}, S_{nzb}, S_{nzc}, Sₘₙ of the output power stage 212 is possible. This allows for power conversion at lower switching losses and thus higher energy efficiency. Also, higher switching frequencies may be used in order to increase the power density (reduced size) and reduce the cost of the electrical converter 200. FIG. 7 shows the currents i_{Lp}, i_{Ln}, iₓ, i_{y}, i_{zap}, i_{zbp}, i_{zcp}, i_{nza}, i_{nzb}, i_{nzc} within a whole line cycle (360°) of the mains voltage in case of ZVS operation of output power stage 212. Also shown are the switching-cycle-averaged values [symbol] i_{Lp} [symbol] , [symbol] i_{Ln} [symbol] , [symbol] iₓ [symbol] , [symbol] i_{y} [symbol] , [symbol] i_{zap} [symbol] , [symbol] i_{zbp} [symbol] , [symbol] i_{zcp} [symbol] , [symbol] i_{zan} [symbol] , [symbol] i_{zbn} [symbol] , [symbol] i_{zcn} [symbol] of these currents which correspond with the currents shown in FIG. 2C.

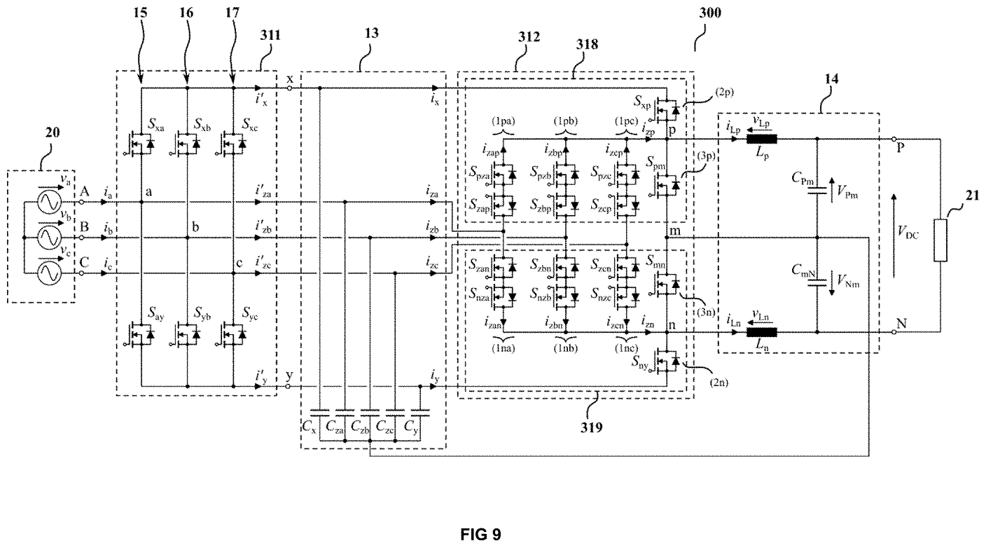

The electrical converters 10 (shown in FIG. 1) and 200 (shown in FIG. 8) are unidirectional since the passive rectifier 11 and the output power stages 12, 212 contain diodes, only allowing power to be drawn from the electrical AC grid 20 and provide this power at the output to a load 21. FIG. 9, on the other hand, shows an electrical converter 300 that is bidirectional. Electrical converter 300 differs from converters 10, 200 in that the diodes Dₐₓ, D_{bx}, D_{cx}, D_{ya}, D_{yb}, D_{yc} of the passive rectifier 11 and the diodes D_{zap}, D_{zbp}, D_{zcp}, Dₘₚ, D_{nza}, D_{nzb}, D_{nzc}, Dₙₘ of the output power stages 12, 212 have been replaced with controllable semiconductor switches Sₓₐ, S_{xb}, S_{xc}, S_{ay}, S_{by}, S_{cy} in the synchronous rectifier 311 and S_{pza}, S_{pzb}, S_{pzc}, Sₚₘ, S_{zan}, S_{zbn}, S_{zcn}, Sₘₙ in the output power stage 312 respectively. It is noted that the electrical converter 300 may be used as a DC-to-AC converter with A, B, C being the output terminals and P, N the input terminals, as will be clear to a person skilled in the art. This may be useful e.g. in applications using solar cells.

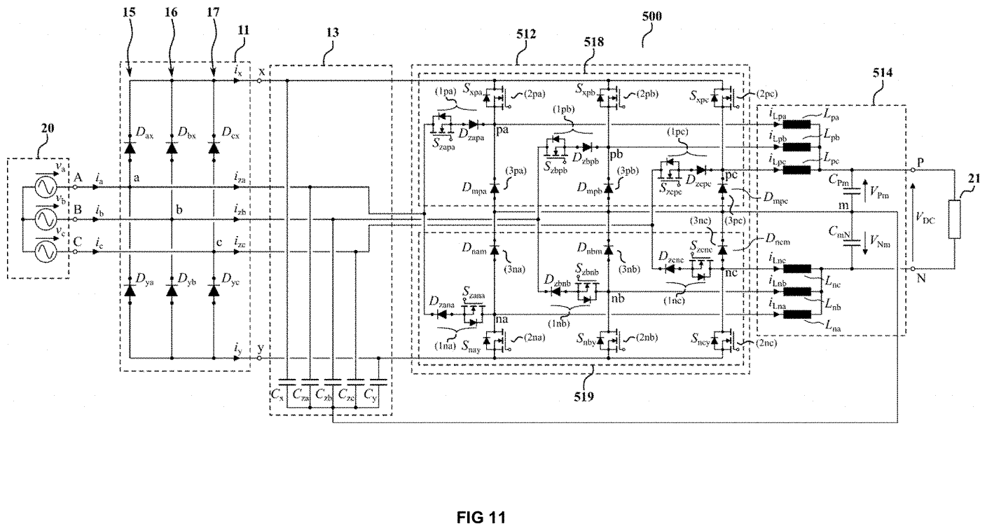

In FIG. 11 another electrical converter 500 is shown which differs from converter 10 in that the stacked buck bridge legs 518, 519 of the output power stage 512 are implemented using a different configuration (parallel configuration) of the diodes and switches. Converter 500 can be used in higher power applications as it provides dedicated buck circuits for each phase leg and the possibility for triple interleaving of the output stage 512. In conjunction, the output filter 514 differs from output filter 14 by the fact that it contains three upper buck inductors Lpa, Lpb, Lpc for connecting the upper buck circuit 518 to upper output terminal P and three lower buck inductors Lna, Lnb, Lnc for connecting the lower buck circuit 519 to the lower output terminal N, for a total of six buck inductors.

The first buck circuit comprises three first devices 1pa, 1pb, 1pc that are actively switchable for connecting three first switch-node terminals pa, pb, pc to any one of the three phase terminals A, B, C. The second buck circuit comprises three further first devices 1na, 1nb, 1nc that are actively switchable for connecting three second switch-node terminals na, nb, nc to any one of the three phase terminals A, B, C. The first buck circuit further comprises three second device 2pa, 2pb, 2pc connected between the first intermediate node x and the three first switch-node terminals pa, pb, pc, and the second buck circuit comprises three further second devices 2na, 2nb, 2nc connected between the second intermediate node y and the three second switch-node terminals na, nb, nc. The first and the second buck circuits are connected in series between the first intermediate node x and the second intermediate node y such that there is a common node m of the first and second buck circuit. The first buck circuit comprises three third devices 3pa, 3pb, 3pc connected between the common node m and the three first switch-node terminals pa, pb, pc, and the second buck circuit comprises three further third devices 3na, 3nb, 3nc connected between the common node m and the three second switch-node terminals na, nb, nc. The three second devices 2pa, 2pb, 2pc and the three further second device 2na, 2nb, 2nc are actively switchable, such that AC-to-DC conversion is possible. In addition or alternatively, the three third devices and the three further third devices may be actively switchable (not shown), to allow for DC-to-AC conversion.

The first buck circuit is configured for controlling connections between the three first switch-node terminals pa, pb, pc and the first intermediate node x, the three phase terminals A, B, C, and the common node m; and the second buck circuit is configured for controlling connections between the three second switch-node terminals na, nb, nc and the second intermediate node y, the three phase terminals A, B, C, and the common node m.

In either electrical converter 10, 200, and 500, diodes may be replaced by current-bidirectional actively switchable semiconductor devices to allow for bidirectional power flow of the electrical converter.

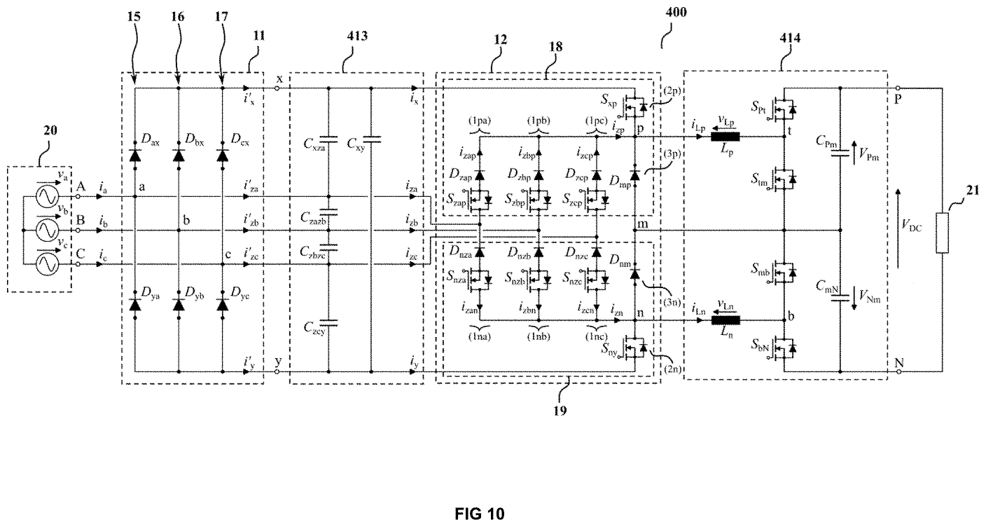

In FIG. 10 another electrical converter 400 is shown which differs from converter 200 in that the output filter 14 is replaced by an active output filter 414 that includes a boost stage. An active output filter may be used in the electrical converters of either FIG. 1, FIG. 8, FIG. 9, FIG. 11. Also, in the electrical converter 400, the HF capacitors C_{xza}, C_{zcy}, C_{zbzc}, C_{zazb}, C_{xy} which interconnect the voltage nodes x, y, a, b, c are connected in a delta configuration instead of a star configuration.

In either electrical converters 10, 200, 300, and 400, the HF capacitors (Cᵣ, C_{za}, C_{zb}, C_{zc}, C_{y}, C_{xza}, C_{zcy}, C_{zbzc}, C_{zazb}, C_{xy}) may be placed between the phase terminals A, B, C and the rectifier 11, 311, and interconnect the phase terminals A, B, C in the form of a star or delta configuration. A combination of a set of HF capacitors which interconnect the intermediate voltage nodes x, y (as in electrical converters 10, 200, 300, 400) and a set of HF capacitors which interconnect the phase input terminals A, B, C, either in the form of a star or delta configuration, or a combination, may also be used.

In either electrical converter 10, 200, 300 and 500, the HF capacitors Cₓ, C_{za}, C_{zb}, C_{zc}, C_{y} are connected in a star configuration. Alternatively, a delta configuration of these capacitors may be used in either of these electrical converters. In electrical converter 400, the HF capacitors C_{xza}, C_{zcy}, C_{zbzc}, C_{zazb}, C_{xy} are connected in a delta configuration. Alternatively, a star configuration of these capacitors may be used.

As shown in FIG. 1, in order to accomplish the piece-wise sinusoidal shapes of intermediate currents i′ₓ, i′_{y}, i′_{za}, i′_{zb}, i′_{zc} which results in three sinusoidal AC phase currents iₐ, i_{b}, i_{c}, a central control unit 40 may be used which controls all the controllable semiconductor devices (switches) of the electrical converter 10, sending control signals to each switch via a communication interface 50. In particular, semiconductor devices S_{zap}, S_{zbp}, S_{zcp}, S_{nza}, S_{nzb}, S_{nzc}, Sₓₚ, S_{ny} are controlled by controller 40. Furthermore, the control unit has measurement input ports 42, 43, 44, 45, 46, for receiving measurements of:
42: the AC-grid phase voltages vₐ, v_{b}, v_{c};
43: the intermediate currents i′ₓ, i′_{y}, i′_{za}, i′_{zb}, i′_{zc},
44: the inductor currents i_{Lp}, i_{Ln}:
45: the DC bus voltage V_{DC};
46: the DC bus mid-point voltage V_{mN},
   and an input port 41 to receive a set-value, which may be a requested DC output voltage V*_{DC}.

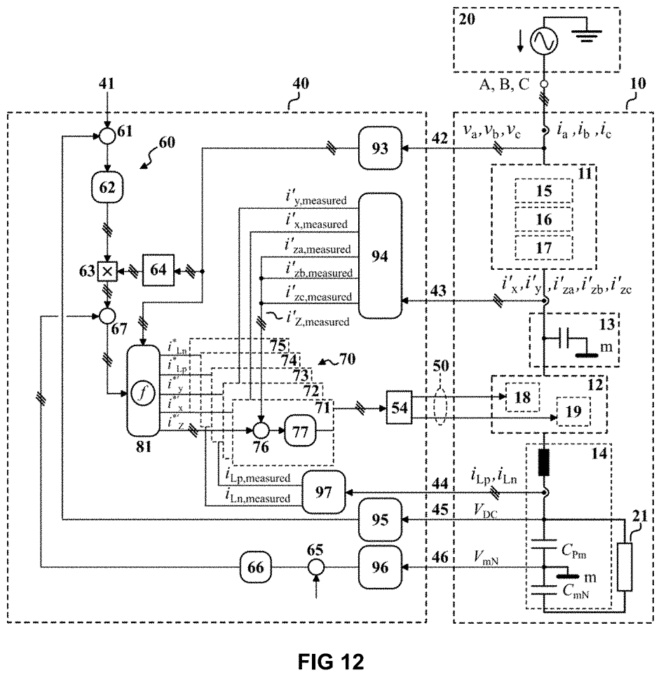

FIG. 12 shows a block diagram of an advantageous implementation of the central control unit 40 which is shown in a schematically way in FIG. 1. The electrical converter 10 is represented in FIG. 12 as a ‘single-wire’ equivalent circuit, wherein the annotations of the elements correspond with those given in FIG. 1. Three slashes in a signal line indicate the bundling of multiple signals, and may represent the transition to a vector representation.

The goal of the control unit 40 is to control the output voltage V_{DC} to a requested set-value V*_{DC} that is received from an external unit via input port 41, and to balance the voltage across the two output capacitors C_{Pm} and C_{mN}, for example by controlling the voltage across the lower output capacitor C_{mN} to be substantially equal to half the DC bus voltage. Additionally, the current drawn from the phase inputs a, b, c may need to be shaped substantially sinusoidal and controlled substantially in phase with the corresponding phase voltage. As explained previously, this can also be achieved by controlling the intermediate currents i′ₓ, i′_{y}, i′_{za}, i′_{zb}, i′_{zc}, i.e., instead of directly controlling the phase currents iₐ, i_{b}, i_{c}, to have piece-wise sinusoidal shapes.

The control of the output voltage V_{DC} is advantageously done using a cascaded control structure, comprising an outer voltage control loop 60 and inner current control loop 70. The set-value of the output voltage is input to a comparator 61 via input port 41, and is compared with the measured output voltage obtained from a measurement means 95 (for example comprising a low-pass filter). The output of comparator 61 is the control-error signal of the output voltage, which is further input to a control element 62 (for example comprising a proportional-integral control block) that outputs instantaneous set-values related to the phase currents and/or set-values related to the DC component of the inductor currents. These set-values are input to multiplier 63, and multiplied with signals that are obtained from calculation element 64 that outputs normalized instantaneous values of the phase voltages. The inputs of calculation element 64 are the measured phase voltages obtained from a measurement means 93 (for example comprising a low-pass filter). The output of the multiplier 63 are set-values i*ₐ, i*_{b}, i*_{c}, i*_{Lp}, i*_{Ln} for the instantaneous, for example low-pass filtered, phase currents iₐ, i_{b}, i_{c}, and the instantaneous, for example low-pass filtered, DC component of inductor currents i_{Lp}, i_{Ln}. Set-values i*ₐ, i*_{b}, i*_{c} are shaped substantially sinusoidal and positioned substantially in phase with the corresponding phase voltages. Set-values are substantially constant and, as explained above, may represent the DC output current to a load 21 as i_{Lp}= [symbol] i_{Lp} [symbol] =I_{DC} and i*_{Ln}= [symbol] i_{Ln} [symbol] =−I_{DC}. The set-values i*ₐ, i*_{b}, i*_{c}, i*_{Lp}, i*_{Ln} are input to the current controller 70 after passing an addition element 67 and a selection element 81 whose functions are further detailed in the following text.

The current controller 70 is split into five individual current controllers 71, 72, 73, 74, 75, wherein:
Individual current controller 71 is used for controlling the middle intermediate currents i′_{za}, i′_{zb}, i′_{zc}. This control is done by PWM modulation of the controllable switches of output power stage 12. As a result of the operation of the passive rectifier 11, therewith, controller 71 controls the current of the phase terminal A, B, C, that has a voltage between the highest voltage and the lowest voltage of the three-phase AC voltage;
Individual current controller 72 is used for controlling the upper intermediate current G. This control is done by PWM modulation of the controllable switches of output power stage 12. As a result of the operation of the passive rectifier 11, therewith, controller 72 controls the current of the phase terminal A, B, C, that has the highest voltage of the three-phase AC voltage;
Individual current controller 73 is used for controlling the lower intermediate current i′_{y}. This control is done by PWM modulation of the controllable switches of output power stage 12. As a result of the operation of the passive rectifier 11, therewith, controller 73 controls the current of the phase terminal A, B, C, that has the lowest voltage of the three-phase AC voltage.
Individual current controller 74 is used for controlling the current in the upper inductor Lₚ of output filter 14, connected to upper buck bridge leg 18. This control is done by PWM modulation of the controllable switches of output power stage 12.
Individual current controller 75 is used for controlling the current in the lower inductor Lₙ of output filter 14, connected to lower buck bridge leg 19. This control is done by PWM modulation of the controllable switches of output power stage 12.
Current controllers 74 and 75 jointly control the current supplied to a load 21.

The skilled person understands that not all current controllers 71, 72, 73, 74, 75 are required. Embodiments of the present disclosure may use any combination of one or more current controllers as defined above, e.g. depending on the application requirements of the electrical converter.

Selector element 81 is used to send the set-values i*ₐ, i*_{b}, i*_{c}, i*_{Lp}, i*_{Ln}, for the instantaneous phase currents and inductor currents to the correct individual current controller 71, 72, 73, 74, 75 depending on the voltage value of the phase terminal A, B, C, resulting in intermediate current set-values i′*ₓ, i′*_{y}, i′*_{z} and inductor current set-values i*_{Lp}, i*_{Ln} for each individual current controller, wherein:
the set-value of the phase current of the phase input A,B,C, that has the highest voltage of the three-phase AC voltage is sent to individual current controller 72, resulting in set-value i*′ₓ;
the set-value of the phase current of the phase input A,B,C, that has the lowest voltage of the three-phase AC voltage is sent to individual current controller 73, resulting in set-value i′*_{y};
the set-value of the phase current of the phase input A,B,C, that has a voltage between the highest voltage and the lowest voltage of the three-phase AC voltage is sent to individual current controller 71, resulting in set-value i′*_{z}=[i′*_{za}, i′*^{zb}, i′*_{zc}].
the set-value of the inductor current of upper inductor Lₚ of the output filter 14 is sent to individual current controller 74, resulting in set-value i*_{Lp}.
the set-value of the inductor current of lower inductor Lₙ of the output filter 14 is sent to individual current controller 75, resulting in set-value i*_{Ln}.

In each individual current controller the received set-value i′*ₓ, i′*_{y}, i′*_{Z}, i′*_{Lp}, i′*_{Ln} for the instantaneous current is input to a comparator, for example comparator 76 of individual current controller 71, and compared with the measured current i′_{x,measured}, i′_{y,measured}, i′_{Z,measured}, i_{Lp,measured}, i_{Ln,measured} obtained from a measurement means 94 (for example comprising a low-pass filter) and from a measurement means 97. The measured current i′_{Z,measured} denotes a vector representation of i′_{za,measured}, i_{zb,measured}, i_{zc,measured} The output of the comparator is the control-error signal of the current, which is further input to a control element, for example control element 77 (for example a proportional-integral controller) of individual current controller 71. The output of current controller 70, which is for example a bundled combination of outputs of individual current controllers 71, 72, 73, 74, 75 is input to a PWM generation element, for example PWM generation element 54. The PWM generation element generates the PWM-modulated control signals for the controllable semiconductor switches of the PWM-controlled bridge legs, i.e. the upper buck bridge leg 18 of the upper buck circuit and the lower buck bridge leg 19 of the lower buck circuit. These PWM-modulated control signals are sent to the appropriate bridge legs via communication interface 50.

DC bus mid-point balancing is done by adding an offset value, by addition element 67, to the set-values i*ₐ, i*_{b}, i*_{c}, i*_{Lp}, i*_{Ln}, for the instantaneous, for example low-pass filtered, phase currents iₐ, i_{b}, i_{c}, and/or instantaneous, for example low-pass filtered, inductor currents i_{Lp}, i_{Ln} which are output by multiplier 63. The offset value is obtained by comparing the measured DC bus midpoint voltage obtained from a measurement means 96 (for example comprising a low-pass filter) with a set-value (for example V_{DC}/2) using comparator 65 and feeding the error signal (output of comparator 65) into a control element 66.

The phase currents iₐ, i_{b}, i_{c} shown in FIG. 2D are obtained by controlling the electrical converter 10 using such control unit 40 and control method detailed in the foregoing text. As explained above, the phase currents iₐ, i_{b}, i_{c} are indirectly controlled, i.e., they are the result of the controlling of the intermediate currents i′ₓ, i′_{y}, i′_{za}, i′_{zb}, i′_{zc} (shown in FIG. 2C) and/or the inductor currents i_{Lp}, i_{Ln} and of the operation of the passive rectifier 11. The set-points for the intermediate currents (i′*ₓ, i′*_{y}, i′*_{z}) are derived from set-values i*ₐ, i*_{b}, i*_{c} by selector element 81 based on the measured phase voltages.

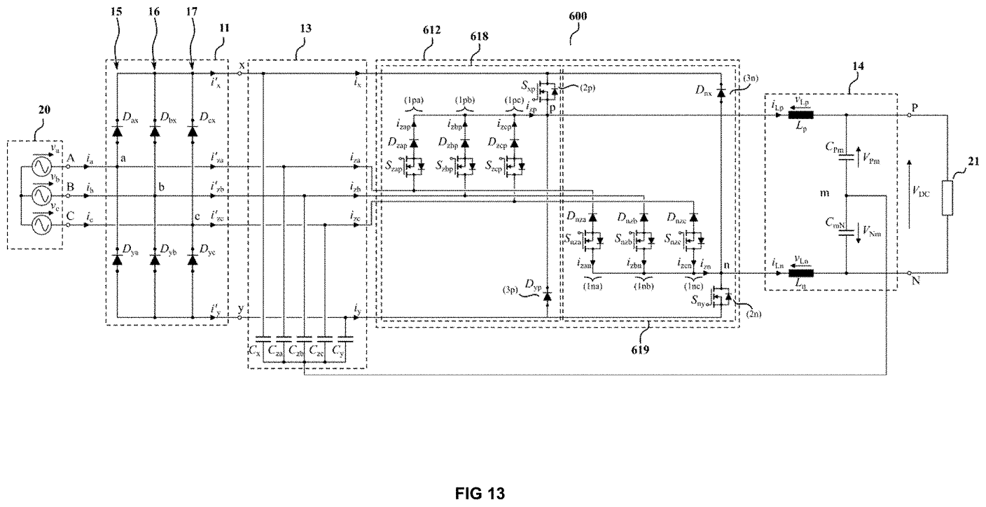

FIG. 13 illustrates yet another exemplary embodiment of an electrical converter 600. The electrical converter comprises a parallel connection of bridge legs 618, 619. More in particular, the first and the second buck circuits are connected in parallel between the first intermediate node and the second intermediate node. The first buck circuit comprises three first devices 1pa, 1pb, 1pc, a second device 2p, and a third device 3p connected between the second intermediate node y and a first switch-node terminal p. The second buck circuit comprises three further first devices 1na, 1nb, 1nc, a further second device 2n, and a further third device 3n connected between the first intermediate node x and a second switch-node terminal n. The third device 3p is connected in series with the three first devices 1pa, 1pb, 1pc between the second intermediate terminal y and the respective phase terminal A, B, C, and the further third device 3n is connected in series with the three further first devices 1na, 1nb, 1nc between the first intermediate terminal x and the respective phase terminal A, B, C.

Also, in the electrical converter 600, diodes of the rectifier 11 may be replaced by actively switchable semiconductor devices to allow for bidirectional power flow of the electrical converter (as in the embodiment of FIG. 9). In electrical converter 600, the HF capacitors are connected in a star configuration. Alternatively, a delta configuration of these capacitors may be used. Also, instead of a passive output filter 14, an active output filter may be used in electrical converter 600 as FIG. 11.

The functions of the functional block labelled as “controller”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

Whilst the principles of the present disclosure have been set out above in connection with specific embodiments, it is to be understood that this description is merely made by way of example and not as a limitation of the scope of protection which is determined by the appended claims.

1. An electrical converter for conversion between a three-phase AC signal and a DC signal, the electrical converter comprising:
three phase terminals (A, B, C),
a first DC terminal (P) and a second DC terminal (N),
a conversion circuitry for conversion between three phase voltages of the three-phase AC signal provided at the three phase terminals (A, B, C) and a first and second intermediate voltage at a first and second intermediate node (x, y) of the electrical converter,
a first buck circuit comprising at least one first switch-node terminal that is operably connected to the first DC terminal (P) and a second buck circuit comprising at least one second switch-node terminal that is operably connected to the second DC terminal (N), wherein the first and the second buck circuits are connected between the first intermediate node (x) and the second intermediate node (y) for conversion between the first and second intermediate voltage and the three phase voltages, on one hand, and the DC signal between the first and second DC terminals (P, N), on the other hand,
wherein the first buck circuit comprises three first devices that are actively switchable for connecting the at least one first switch-node terminal to any one of the three phase terminals (A, B, C), and in that the second buck circuit comprises three further first devices that are actively switchable for connecting the at least one second switch-node terminal to any one of the three phase terminals (A, B, C),
wherein the first buck circuit comprises at least one second device that is switchable and connected between the first intermediate node (x) and the at least one first switch-node terminal, and at least one first filter inductor connected between the at least one first switch-node terminal and the first DC terminal (P) and wherein the second buck circuit comprises at least one further second device that is switchable and connected between the second intermediate node (y) and the at least one second switch-node terminal, and at least one second filter inductor connected between the at least one second switch-node terminal and the second DC terminal (N),
wherein the first and the second buck circuits are connected in series between the first intermediate node (x) and the second intermediate node (y) such that there is a common node (m) of the first and second buck circuit; wherein the first buck circuit comprises at least one third device connected between the common node (m) and the at least one first switch-node terminal; wherein the second buck circuit comprises at least one further third device connected between the common node (m) and the at least one second switch-node terminal.

2. The electrical converter of claim 1, wherein the at least one second device and the at least one further second device are actively switchable.

3. (canceled)

4. The electrical converter of claim 1, wherein the at least one third device and the at least one further third device are actively switchable.

5. The electrical converter of claim 1, wherein the first buck circuit is configured to control connections between the at least one first switch-node terminal and the first intermediate node (x), the three phase terminals (A, B, C), and the common node (m); and wherein the second buck circuit is configured to control connections between the at least one second switch-node terminal and the second intermediate node (y), the three phase terminals (A, B, C), and the common node (m).

6. The electrical converter of claim 1, further comprising a controller configured to control at least one of the conversion circuitry and the first and second buck circuit.

7. The electrical converter of claim 1, further comprising at least two filter capacitors connected between the first and second DC terminals (P, N).

8. The electrical converter of claim 7, wherein the common node (m) is connected to a midpoint of a series connection of the at least two filter capacitors.

9. The electrical converter of claim 1, further comprising a filter comprising capacitors which interconnect the first intermediate node (x), the second intermediate node (y) and the three phase terminals (A, B, C).

10. The electrical converter of claim 9, wherein the capacitors are connected to the common node (m).

11. The electrical converter of claim 6, comprising measurement means configured to measure at least one of the DC signal, an electrical signal influencing the DC signal, an electrical signal influenced by the DC signal, and wherein the controller comprises a control loop configured to adapt at least one pulse width modulation control signal for controlling at least one of the first and second buck circuit based on measurements of the measurement means.

12. (canceled)

13. The electrical converter of claim 1, wherein the conversion circuitry comprises three phase legs configured to interconnect one of the three phase terminals (A, B, C) to any one of the first intermediate node (x) and the second intermediate node (y), wherein each of the three phase legs comprises a half bridge comprising semiconductor devices.

14. The electrical converter of claim 13, wherein the semiconductor devices of the three phase legs are actively switchable.

15. A battery charging system, comprising a power supply unit, the power supply unit comprising the electrical converter of claim 1.

16. An electric motor drive system, comprising a power supply unit, the power supply unit comprising the electrical converter of claim 1.

17. A gradient amplifier comprising the electrical converter of claim 1.

18. A method of converting between a three-phase AC signal and a DC signal, comprising:
converting between a first, second and third phase voltage of the three-phase AC signal and a first and a second intermediate voltage, wherein the first intermediate voltage is applied on a first intermediate node (x) and the second intermediate voltage is applied on a second intermediate node (y), wherein a phase signal of the three-phase AC signal having a highest voltage is continuously applied to the first intermediate node (x) and a phase signal of the three-phase AC signal having a lowest voltage is continuously applied to the second intermediate node (y), and
converting between the first and second intermediate voltages and the first, second and third phase voltages, on one hand, and the DC signal, on the other hand, using a first and a second buck circuit, comprising using at least one first filter inductor connected between at least one first switch-node terminal and a first DC terminal (P) and at least one second filter inductor connected between at least one second switch-node terminal and a second DC terminal (N), respectively, wherein the respective first and second intermediate voltage and the respective first, second and third phase voltage are intermittently connected to the at least one first switch-node terminal of the first buck circuit during respective time intervals and to the at least one second switch-node terminal of the second buck circuit during further respective time intervals.

19. The method of claim 18, wherein the first and second buck circuits are controlled such that the respective time intervals and the further respective time intervals are periodic time intervals, said respective time intervals and further respective time intervals covering together a period of the three-phase AC signal.

20. The method of claim 18, wherein the first and the second buck circuits are connected in series between the first intermediate node (x) and the second intermediate node (y) such that there is a common node (m) of the first and second buck circuit.

21. The method of the preceding claim 20, wherein during each respective time interval, the at least one first switch-node terminal of the first buck circuit is alternately connected to the first intermediate node, the respective first, second, and third phase voltage, and the common node (m), while the at least one second switch-node terminal of the second buck circuit is alternately connected to the second intermediate node and the common node; and wherein during each further respective time interval, the at least one second switch-node terminal of the second buck circuit is alternately connected to the second intermediate node, the respective first, second, and third phase voltage, and the common node (m), while the at least one first switch-node terminal of the first buck circuit is alternately connected to the first intermediate node and the common node.

22. The method of claim 18, wherein the converting between the intermediate signal and the DC signal using a first and a second buck circuit comprises controlling at least one of a duty cycle, a switching frequency, and a conduction sequence of control signals to control the first and second buck circuit.
